(19) United States
(12) Patent Application Publication
(10) Pub. No.: US 2026/0238597 A1
(43) Pub. Date: Aug. 13, 2026

(54) COMMUNICATION METHOD, APPARATUS, AND SYSTEM FOR MISSION SESSION

(71) Applicant: Huawei Technologies Co., Ltd., Shenzhen (CN)

(72) Inventors: Chenchen Yang, Ottawa (CA); Xu Li, Nepean (CA); Hang Zhang, Ottawa (CA); Weisen Shi, Kanata (CA)

(21) Appl. No.: 19/631,439

(22) Filed: Mar. 27, 2026

Related U.S. Application Data
(63) Continuation of application No. PCT/CN2024/084248, filed on Mar. 27, 2024.
(60) Provisional application No. 63/541,522, filed on Sep. 29, 2023.

(51) Int. Cl. H04L 47/24; H04L 12/46

(52) U.S. Cl. CPC H04L 47/24; H04L 12/4633

(57) ABSTRACT

Provided are a communication method, apparatus, and system for a mission session. The method includes: receiving a packet; and transmitting a general packet radio service (GPRS) tunneling protocol for user plane (GTP-U) packet generated based on the packet and GTP-U protocol, where the GTP-U packet includes information on a mission session, the mission session is to provide a mission service to a mission user, and the mission service is a service for both protocol data unit (PDU) connectivity and data processing.

### CROSS-REFERENCE TO RELATED APPLICATIONS

This application is a continuation of International Patent Application No. PCT/CN2024/084248, filed on Mar. 27, 2024, which claims the benefits of U.S. Provisional Application No. 63/541,522, filed on Sep. 29, 2023, the disclosures of which are hereby incorporated by reference in their entireties.

### TECHNICAL FIELD

The present disclosure relates generally to the field of communications technologies and, in particular, to a communication method, apparatus, and system for a mission session.

### BACKGROUND

Many new trends will trigger the consideration and design of 6G/future wireless networks: new network infrastructure capability, e.g., cloud natured/friendly infrastructures that are broadly deployed; new (relative) matured techniques, e.g., AI large scale models, Data de-privacy, Block chain, etc. that have made significant progresses and significantly impact on the entire society and human life; new apps and services, e.g., AI services, Data (sensing) service, Digital world service, etc. that are broadly applied in industry/business and used by individual customers; more global/open/collaborative operation trend, i.e., a more open and more collaborative operation mode are becoming common practice in many fields.

However, for a next generation (e.g. sixth generation (6G) or later) network, or a legacy (e.g. fifth generation (5G), fourth generation (4G), third generation (3G) or second generation (2G)) network, e.g., in 6G era, the 6G network is expected not only for connectivity, but also for data processing.

This background information is provided to reveal information believed by the applicant to be of possible relevance to the present application. No admission is necessarily intended, nor should be construed, that any of the preceding information constitutes prior art against the present application.

### SUMMARY

In a first aspect, a communication method is provided in the present disclosure, including:

receiving a packet; and

transmitting a general packet radio service (GPRS) tunneling protocol for user plane (GTP-U) packet generated based on the packet and GTP-U protocol, where the GTP-U packet includes information on a mission session, the mission session is to provide a mission service to a mission customer, and the mission service is a service for both protocol data unit (PDU) connectivity and data processing.

In this way, the mission service can be supported by the information on a mission session included in the GTP-U packet.

In a second aspect, a communication method is provided in the present disclosure, including:

receiving a general packet radio service (GPRS) tunneling protocol for user plane (GTP-U) packet, where the GTP-U packet is a packet based on GTP-U protocol, the GTP-U packet includes information on a mission session, the mission session is to provide a mission service to a mission customer, and the mission service is a service for both protocol data unit (PDU) connectivity and data processing; and

determining, according to the information on a mission session, which mission session the GTP-U packet belongs to.

In this way, by virtue of the information on a mission session, a network entity receiving the GTP-U packet can recognize which mission session the GTP-U packet belongs to.

In a possible implementation of the first aspect or the second aspect, the mission session includes one or more data sessions, each data session includes an association that terminates at a computing block (CB) entity executing at least one CB of a mission, the mission includes one or more CBs and each CB corresponds to a computational step toward achieving the mission service.

In a possible implementation of the first aspect or the second aspect, the data processing includes the executing the at least one CB of the mission.

In a possible implementation of the first aspect or the second aspect, the CB entity is deployed in one of: a device, a radio access network (RAN), a core network (CN), and a data network (DN).

In a possible implementation of the first aspect or the second aspect, the computational step toward achieving the mission service includes one or more of: artificial intelligence (AI) training, AI inference, data pre-processing, data privacy protection, data cleaning, data collection, data analytics, sensing, data sanitization, data management, data normalization, data aggregation, data splitting, useless data filtering, data formatting, data adaptation, data feature engineering, data compression, data embedding, data representation learning, or data feature extraction.

In a possible implementation of the first aspect or the second aspect, the mission session further includes one or more inter-gateway (GW) sessions, each inter-GW session includes an association between two GW entities, and each GW entity is used for supporting communication among CB entities.

In a possible implementation of the first aspect or the second aspect, the information on a mission session is included in a packet header of the GTP-U packet or a payload of the GTP-U packet.

In a possible implementation of the first aspect or the second aspect, the GTP-U packet is transmitted through a GTP-U tunnel, and the GTP-U tunnel is dedicated for a data session.

In other words, the granularity of the GTP-U tunnel can be the data session.

In a possible implementation of the first aspect or the second aspect, the information on a mission session includes a quality of service (QoS) flow identifier (QFI) and/or a computing block ID (CBID), where the QFI indicates a QoS flow associated with the GTP-U packet, the QoS flow is one of one or more QoS flows included in the data session, the CBID indicates a first CB associated with the GTP-U packet, and the data session corresponds to the one or more CBs including the first CB.

In a possible implementation of the first aspect or the second aspect, the information on a mission session is included in a packet header of the GTP-U packet, the packet header includes a GTP-U extension header, and the QFI and/or the CBID is included in the GTP-U extension header.

In a possible implementation of the first aspect or the second aspect, the GTP-U extension header is a first type of GTP-U extension header, the first type of GTP-U extension header is a data session container.

In this way, a new type of extension header (i.e., a data session container) for the granularity per data session is defined, since the GTP-U tunnel is dedicated for a data session of a mission session, a network entity receiving a GTP-U packet including the data session container from a tunnel can determine the data session which the GTP-U packet belongs to quickly and accurately.

In a possible implementation of the first aspect or the second aspect, the information on a mission session includes a first field, the first type of GTP-U extension header is indicated by the first field.

In a possible implementation of the first aspect or the second aspect, a value of the first field is 10001000.

In a possible implementation of the first aspect or the second aspect, the first field indicates that the GTP-U tunnel is dedicated for the data session through indicating the first type of GTP-U extension header.

In a possible implementation of the first aspect or the second aspect, the GTP-U extension header is a second type of GTP-U extension header, and an indication is included in the GTP-U packet to indicate whether the second type of GTP-U extension header is for a data session.

In this way, an existing container (e.g., a PDU session container) can be reused for distinguishing a data session which the received GTP-U packet belongs to.

In a possible implementation of the first aspect or the second aspect, the indication is included in the second type of GTP-U extension header, or,

the information on a mission session includes a second field, the indication is included in the second field.

In a possible implementation of the first aspect or the second aspect, the indication is 2 bits, and a value of the 2 bits indicates that the second type of GTP-U extension header is for a PDU session or a data session.

In a possible implementation of the first aspect or the second aspect, the information on a mission session includes a second field, and the indication is indicated by a range of values of the second field.

In a possible implementation of the first aspect or the second aspect, the GTP-U packet is transmitted through a GTP-U tunnel, and the GTP-U tunnel is dedicated for an inter-GW session.

In other words, the granularity of the GTP-U tunnel can be the inter-GW session.

In a possible implementation of the first aspect or the second aspect, the information on a mission session includes a QFI and/or a CBID, where the QFI indicates a QoS flow associated with the GTP-U packet, the QoS flow is one of one or more QoS flows included in the inter-GW session, the CBID indicates a first CB associated with the GTP-U packet, and one data session or one inter-GW session corresponds to the one or more CBs including the first CB.

In a possible implementation of the first aspect or the second aspect, the information on a mission session is included in a packet header of the GTP-U packet, the packet header includes a GTP-U extension header, and the QFI and/or the CBID is included in the GTP-U extension header.

In a possible implementation of the first aspect or the second aspect, the GTP-U extension header is a first type of GTP-U extension header, the first type of GTP-U header is an inter-GW session container.

In this way, a new type of extension header (i.e., an inter-GW session container) for the granularity per inter-GW session is defined, since the GTP-U tunnel is dedicated for an inter-GW session of a mission session, a network entity receiving a GTP-U packet including the inter-GW session container from a tunnel can determine the inter-GW session which the GTP-U packet belongs to quickly and accurately.

In a possible implementation of the first aspect or the second aspect, the information on a mission session includes a first field, the first type of GTP-U extension header is indicated by the first field.

In a possible implementation of the first aspect or the second aspect, a value of the first field is 10001001.

In a possible implementation of the first aspect or the second aspect, the first field indicates that the GTP-U tunnel is dedicated for the inter-GW session through indicating the first type of GTP-U extension header.

In a possible implementation of the first aspect or the second aspect, the GTP-U extension header is a second type of GTP-U extension header, and an indication is included in the GTP-U packet to indicate whether the second type of GTP-U extension header is for an inter-GW session.

In this way, an existing container (e.g., a PDU session container) can be reused for distinguishing an inter-GW session which the received GTP-U packet belongs to.

In a possible implementation of the first aspect or the second aspect, the indication is included in the second type of GTP-U extension header, or,

the information on a mission session includes a second field, the indication is included in the second field.

In a possible implementation of the first aspect or the second aspect, the indication is 2 bits, and a value of the 2 bits indicates that the second type of GTP-U extension header is for a PDU session or an inter-GW session.

In a possible implementation of the first aspect or the second aspect, the information on a mission session includes a second field, and the indication is indicated by a range of values of the second field.

In a possible implementation of the first aspect or the second aspect, the GTP-U packet is transmitted through a GTP-U tunnel, and the GTP-U tunnel is dedicated for the mission session and is shared by one or more data sessions and/or one or more inter-GW sessions of the mission session.

In other words, the granularity of the GTP-U tunnel can be the mission session.

In a possible implementation of the first aspect or the second aspect, the information on a mission session includes either or both of a data session ID and assistance information, the data session ID is used to identify a data session included in the one or more data sessions, and the assistance information is used for assisting in distinguishing the data session or distinguishing a CB.

In a possible implementation of the first aspect or the second aspect, the information on a mission session further includes a QFI and/or a CBID, where the QFI indicates a QoS flow associated with the GTP-U packet, the QoS flow is one of one or more QoS flows included in the data session; the CBID indicates a first CB associated with the GTP-U packet, and the data session corresponds to the one or more CBs including the first CB.

In a possible implementation of the first aspect or the second aspect, the information on a mission session includes either or both of an inter-GW session ID and assistance information, the inter-GW session ID is used to identify an inter-GW session, and the assistance information is used for assisting in distinguishing the inter-GW session or distinguishing a CB.

In a possible implementation of the first aspect or the second aspect, the information on a mission session further includes a QFI and/or a CBID, where the QFI indicates a QoS flow associated with the GTP-U packet, the QoS flow is one of one or more QoS flows included in the inter-GW session; the CBID indicates a first CB associated with the GTP-U packet, and one data session or one inter-GW session corresponds to the one or more CBs including the first CB.

In a possible implementation of the first aspect or the second aspect, the information on a mission session includes a QFI and/or a CBID, where the QFI indicates a QoS flow associated with the GTP-U packet, the QoS flow is one of one or more QoS flows of the mission session; the CBID indicates a first CB associated with the GTP-U packet, and one data session or one inter-GW session corresponds to the one or more CBs including the first CB.

In a possible implementation of the first aspect or the second aspect, the information on a mission session is included in a packet header of the GTP-U packet, the packet header includes a GTP-U extension header, and one or more of: the data session ID, the inter-GW session ID, the assistance information, the QFI or the CBID, is included in the GTP-U extension header.

In a possible implementation of the first aspect or the second aspect, the GTP-U extension header is a first type of GTP-U extension header, and the first type of GTP-U extension header is a mission session container.

In this way, a new type of extension header (i.e., a mission session container) for the granularity per mission session is defined, since the GTP-U tunnel is dedicated for a mission session, a network entity receiving a packet including the mission session container from a tunnel can determine the mission session which the GTP-U packet belongs to, and further determine a data session (or an inter-GW session) which the GTP-U packet belongs to, according to the information on a mission session (such as, a data session ID, an inter-GW session ID and assistance information) included in the mission session container.

In a possible implementation of the first aspect or the second aspect, the information on a mission session includes a first field, the first type of GTP-U extension header is indicated by the first field.

In a possible implementation of the first aspect or the second aspect, a value of the first field value is 10001010.

In a possible implementation of the first aspect or the second aspect, the first field indicates that the GTP-U tunnel is dedicated for the mission session through indicating the first type of GTP-U extension header.

In this way, an existing container (e.g., a PDU session container) can be reused for distinguishing the mission session, and further a data session (or an inter-GW session) of the mission session which the received GTP-U packet belongs to.

In a possible implementation of the first aspect or the second aspect, the GTP-U extension header is a second type of GTP-U extension header, and an indication is included in the GTP-U packet to indicate whether the second type of GTP-U extension header is for a mission session.

In a possible implementation of the first aspect or the second aspect, the indication is included in the second type of GTP-U extension header, or,

the information on a mission session includes a second field, the indication is included in the second field.

In a possible implementation of the first aspect or the second aspect, the indication is 2 bits, and a value of the 2 bits indicates that the second type of GTP-U extension header is for a PDU session or a mission session.

In a possible implementation of the first aspect or the second aspect, the information on a mission session includes a second field, and the indication is indicated by a range of values of the second field.

In a possible implementation of the first aspect or the second aspect, the GTP-U packet is transmitted through a GTP-U tunnel, the GTP-U tunnel is dedicated for a CB entity and is shared by one or more mission sessions of the CB entity, and the one or more mission sessions include the mission session.

In other words, the granularity of the GTP-U tunnel can be the CB entity.

In a possible implementation of the first aspect or the second aspect, the information on a mission session includes one or more of: a mission session ID, a data session ID or assistance information; the mission session ID is used to identify a first mission session, the data session ID is used to identify a data session included in the first mission session, and the assistance information is used for assisting in distinguishing the data session or distinguishing a CB.

In a possible implementation of the first aspect or the second aspect, the information on a mission session further includes a QFI and/or a CBID, where the QFI indicates a QoS flow associated with the GTP-U packet, the QoS flow is one of one or more QoS flows included in the data session; the CBID indicates a first CB associated with the GTP-U packet, and the data session corresponds to the one or more CBs including the first CB.

In a possible implementation of the first aspect or the second aspect, the information on a mission session includes a QFI and/or a CBID, where the QFI indicates a QoS flow associated with the GTP-U packet, the QoS flow is one of one or more QoS flows of the one or more mission sessions of the CB entity, the CBID indicates a first CB associated with the GTP-U packet, and the data session corresponds to the one or more CBs including the first CB.

In a possible implementation of the first aspect or the second aspect, the information on a mission session is included in a packet header of the GTP-U packet, the packet header includes a GTP-U extension header, and one or more of: the mission session ID, the data session ID, the assistance information, the QFI or the CBID, is included in the GTP-U extension header.

In a possible implementation of the first aspect or the second aspect, the GTP-U extension header is a first type of GTP-U extension header, the first type of GTP-U extension header is a CB entity container.

In this way, a new type of extension header (i.e., a CB entity container) for the granularity per CB entity is defined, a network entity receiving a GTP-U packet including the CB entity container from a tunnel can determine a data session of a mission session which the packet belongs to, according to the information on a mission session (such as, a mission session ID, a data session ID and assistance information) included in the CB entity container.

In a possible implementation of the first aspect or the second aspect, the information on a mission session includes a first field, and the first type of GTP-U extension header is indicated by the first field.

In a possible implementation of the first aspect or the second aspect, a value of the first field is 10001011.

In a possible implementation of the first aspect or the second aspect, the first field indicates that the GTP-U tunnel is dedicated for the CB entity through indicating the first type of GTP-U extension header.

In a possible implementation of the first aspect or the second aspect, the GTP-U extension header is a second type of GTP-U extension header, and an indication is included in the GTP-U packet to indicate whether the second type of GTP-U extension header is for a CB entity.

In this way, an existing container (e.g., a PDU session container) can be reused for distinguishing a mission session, and further a data session of the mission session which the received GTP-U packet belongs to.

In a possible implementation of the first aspect or the second aspect, the indication is included in the second type of GTP-U extension header, or,

the information on a mission session includes a second field, the indication is included in the second field.

In a possible implementation of the first aspect or the second aspect, the indication is 2 bits, and a value of the 2 bits indicates that the second type of GTP-U extension header is for a PDU session or a CB entity.

In a possible implementation of the first aspect or the second aspect, the information on a mission session includes a second field, and the indication is indicated by a range of values of the second field.

In a possible implementation of the first aspect or the second aspect, the GTP-U packet is transmitted through a GTP-U tunnel, the GTP-U tunnel is dedicated for a GW entity and is shared by one or more mission sessions of the GW entity, and the one or more mission sessions include the mission session.

In other words, the granularity of the GTP-U tunnel can be the GW entity.

In a possible implementation of the first aspect or the second aspect, the information on a mission session includes one or more of: a mission session ID, a data session ID or first assistance information, or includes one or more of: a mission session ID, an inter-GW session ID or second assistance information;

the mission session ID is used to identify a first mission session, the data session ID is used to identify a data session included in the first mission session, and the first assistance information is used for assisting in distinguishing the data session or distinguishing a CB; or

the mission session ID is used to identify a first mission session, the inter-GW session ID is used to identify an inter-GW session included in the first mission session, and the second assistance information is used for assisting in distinguishing the inter-GW session or distinguishing a CB.

In a possible implementation of the first aspect or the second aspect, the information on a mission session further includes a QFI and/or a CBID, where the QFI indicates a QoS flow associated with the GTP-U packet, the QoS flow is one of one or more QoS flows included in the data session or in the inter-GW session; the CBID indicates a first CB associated with the GTP-U packet, and one data session or one inter-GW session corresponds to the one or more CBs including the first CB.

In a possible implementation of the first aspect or the second aspect, the information on a mission session includes a QFI and/or a CBID, where the QFI indicates a QoS flow associated with the GTP-U packet, the QoS flow is one of one or more QoS flows of the one or more mission sessions of the GW entity, the CBID indicates a first CB associated with the GTP-U packet, and one data session or one inter-GW session corresponds to the one or more CBs including the first CB.

In a possible implementation of the first aspect or the second aspect, the information on a mission session is included in a packet header of the GTP-U packet, the packet header includes a GTP-U extension header, and one or more of: the mission session ID, the data session ID, the inter-GW session ID, the first assistance information, the second assistance information, the QFI or the CBID, is included in the GTP-U extension header.

In a possible implementation of the first aspect or the second aspect, the GTP-U extension header is a first type of GTP-U extension header, the first type of GTP-U extension header is a GW entity container.

In this way, a new type of extension header (i.e., an GW entity container) for the granularity per GW entity is defined, a network entity receiving a GTP-U packet including the GW entity container from a tunnel can determine a data session (or an inter-GW session) of a mission session which the GTP-U packet belongs to, according to the information on a mission session (such as, a mission session ID, a data session ID, an inter-GW session ID and assistance information) included in the GW entity container.

In a possible implementation of the first aspect or the second aspect, the information on a mission session includes a first field, the first type of GTP-U extension header is indicated by the first field.

In a possible implementation of the first aspect or the second aspect, a value of the first field is 10001100.

In a possible implementation of the first aspect or the second aspect, the first field indicates that the GTP-U tunnel is dedicated for the GW entity through indicating the first type of GTP-U extension header.

In a possible implementation of the first aspect or the second aspect, the GTP-U extension header is a second type of GTP-U extension header, and an indication is included in the GTP-U packet to indicate whether the second type of GTP-U extension header is for a GW entity.

In this way, an existing container (e.g., a PDU session container) can be reused for distinguishing a mission session, and further a data session (or an inter-GW session) of the mission session which the received GTP-U packet belongs to.

In a possible implementation of the first aspect or the second aspect, the indication is included in the second type of GTP-U extension header, or,

the information on a mission session includes a second field, the indication is included in the second field.

In a possible implementation of the first aspect or the second aspect, the indication is 2 bits, and a value of the 2 bits indicates that the second type of GTP-U extension header is for a PDU session or a GW entity.

In a possible implementation of the first aspect or the second aspect, the information on a mission session includes a second field, and the indication is indicated by a range of values of the second field.

In a possible implementation of the first aspect or the second aspect, the second field is a tunnel endpoint identifier (TEID).

In a possible implementation of the first aspect or the second aspect, the assistance information, the first assistance information, or the second assistance information includes one or more of: an action ID identifying an action of data processing, a CBID identifying a CB, a step ID identifying a step of a procedure, or a mission customer ID identifying a customer of a mission session.

In a possible implementation of the first aspect or the second aspect, the second type of GTP-U extension header includes one or more of: a PDU session container, a radio access network (RAN) container, a (new radio) NR RAN container, or an Xw RAN container.

In a possible implementation of the first aspect or the second aspect, the mission service is reduced to a service for PDU connectivity only.

In a possible implementation of the first aspect or the second aspect, the mission session is reduced to a PDU session to be used for the PDU connectivity.

In a possible implementation of the first aspect or the second aspect, there is no CB entity involved in the mission session, or all CB entities involved in the mission session are dummy CB entities.

In a possible implementation of the first aspect or the second aspect, there is no data session belonging to the mission session, or all data sessions belong to the mission session are dummy data sessions.

In a third aspect, a communication apparatus is provided in the present disclosure, including:

a receiving module, configured to receive a packet; and

a transmitting module, configured to transmit a general packet radio service (GPRS) tunneling protocol for user plane (GTP-U) packet generated based on the packet and GTP-U protocol, where the GTP-U packet includes information on a mission session, the mission session is to provide a mission service to a mission customer, and the mission service is a service for both protocol data unit (PDU) connectivity and data processing.

In a fourth aspect, a communication apparatus is provided in the present disclosure, including:

a receiving module, configured to receive a general packet radio service (GPRS) tunneling protocol for user plane (GTP-U) packet, where the GTP-U packet is a packet based on GTP-U protocol, the GTP-U packet includes information on a mission session, the mission session is to provide a mission service to a mission customer, and the mission service is a service for both protocol data unit (PDU) connectivity and data processing; and

a determining module, configured to determine, according to the information on a mission session, which mission session the GTP-U packet belongs to.

In a fifth aspect, an apparatus is provided in the present disclosure, including processing circuitry for performing the method in the first aspect or the second aspect or any possible implementations of the first aspect or the second aspect.

In a sixth aspect, a chip is provided in the present disclosure, including an input/output (I/O) interface and a processor, where the processor is configured to call and run a computer program stored in a memory, to enable a device installing with the chip to perform the method in the first aspect or the second aspect or any possible implementations of the first aspect or the second aspect.

In a seventh aspect, an apparatus is provided in the present disclosure, including:

one or more processors,

the one or more processors is configured to execute instructions stored in a memory, when the instructions are executed by the one or more processors, the method in the first aspect or any possible implementations of the first aspect is performed.

In an eighth aspect, an apparatus is provided in the present disclosure, including:

one or more processors,

the one or more processors is configured to execute instructions stored in a memory, when the instructions are executed by the one or more processors, the method in the second aspect or any possible implementations of the second aspect is performed.

In a ninth aspect, a communication system is provided in the present disclosure, including the apparatus in the seventh aspect and the apparatus in the eighth aspect.

In a tenth aspect, a non-transitory computer-readable medium is provided in the present disclosure, carrying a program code which, when executed by a processor, the method in the first aspect or the second aspect or any possible implementations of the first aspect or the second aspect is performed.

In an eleventh aspect, a computer program product is provided in the present disclosure, including program code for performing the method in the first aspect or the second aspect or any possible implementations of the first aspect or the second aspect.

### BRIEF DESCRIPTION OF DRAWINGS

The accompanying drawings are used to provide a further understanding of the present disclosure, constitute a part of the specification, and are used to explain the present disclosure together with the following specific example embodiments, but should not be construed as limiting the present disclosure.

FIG. 1 is a simplified schematic illustration of a communication system according to one or more embodiments of the present disclosure.

FIG. 2 is a schematic illustration of an example communication system according to one or more embodiments of the present disclosure.

FIG. 3 is a schematic illustration of a basic component structure of a communication system according to one or more embodiments of the present disclosure.

FIG. 4 illustrates a block diagram of a device in a communication system according to one or more embodiments of the present disclosure.

FIG. 5 illustrates a block diagram of 6G System conceptual structure according to one or more embodiments of the present disclosure.

FIG. 6 is a schematic illustration of 5G PDU session according to one or more embodiments of the present disclosure.

FIG. 7 is a schematic illustration of an outline of a GTP-U packet header according to one or more embodiments of the present disclosure.

FIG. 8 is a schematic illustration of definitions of extension header types according to one or more embodiments of the present disclosure.

FIG. 9 is a schematic illustration of a format of a GTP-U extension header according to one or more embodiments of the present disclosure.

FIG. 10 is a schematic illustration of a format of downlink (DL) PDU session information according to one or more embodiments of the present disclosure.

FIG. 11 is a schematic illustration of a format of uplink (UL) PDU session information according to one or more embodiments of the present disclosure.

FIG. 12 is a schematic illustration of a mission service provided by a 6G network according to one or more embodiments of the present disclosure.

FIG. 13 is a schematic illustration of a mission session for a mission service according to one or more embodiments of the present disclosure.

FIG. 14 is a schematic illustration of tunnels configured per data (inter-GW) session according to one or more embodiments of the present disclosure.

FIG. 15 is a schematic illustration of tunnels configured per mission session according to one or more embodiments of the present disclosure.

FIG. 16 is a schematic illustration of tunnels configured per network entity according to one or more embodiments of the present disclosure.

FIG. 17 is a schematic flowchart of a communication method according to one or more embodiments of the present disclosure.

FIG. 18 is a schematic illustration of definitions of extension header types according to one or more embodiments of the present disclosure.

FIG. 19 is a schematic illustration of an evolved format of downlink (DL) PDU session information according to one or more embodiments of the present disclosure.

FIG. 20 is a schematic illustration of definitions of extension header types according to one or more embodiments of the present disclosure.

FIG. 21 is a schematic illustration of a format of DL mission session information according to one or more embodiments of the present disclosure.

FIG. 22 is a schematic illustration of definitions of extension header types according to one or more embodiments of the present disclosure.

FIG. 23 is a schematic illustration of a format of DL CB entity information according to one or more embodiments of the present disclosure.

FIG. 24 is a schematic illustration of a format of DL GW entity information according to one or more embodiments of the present disclosure.

FIG. 25 is a structural diagram of a communication apparatus according to one or more embodiments of the present disclosure.

### DESCRIPTION OF EMBODIMENTS

In the following description, reference is made to the accompanying figures, which form part of the present disclosure, and which show, by way of illustration, specific aspects of examples of the present disclosure or specific aspects in which examples of the present disclosure may be used. It is understood that examples of the present disclosure may be used in other aspects and include structural or logical changes not depicted in the figures. The following detailed description, therefore, is not to be taken in a limiting sense, and the scope of the present disclosure is defined by the appended claims.

To assist in understanding the present disclosure, examples of wireless communication systems and devices are described below.

### Example communication systems and devices

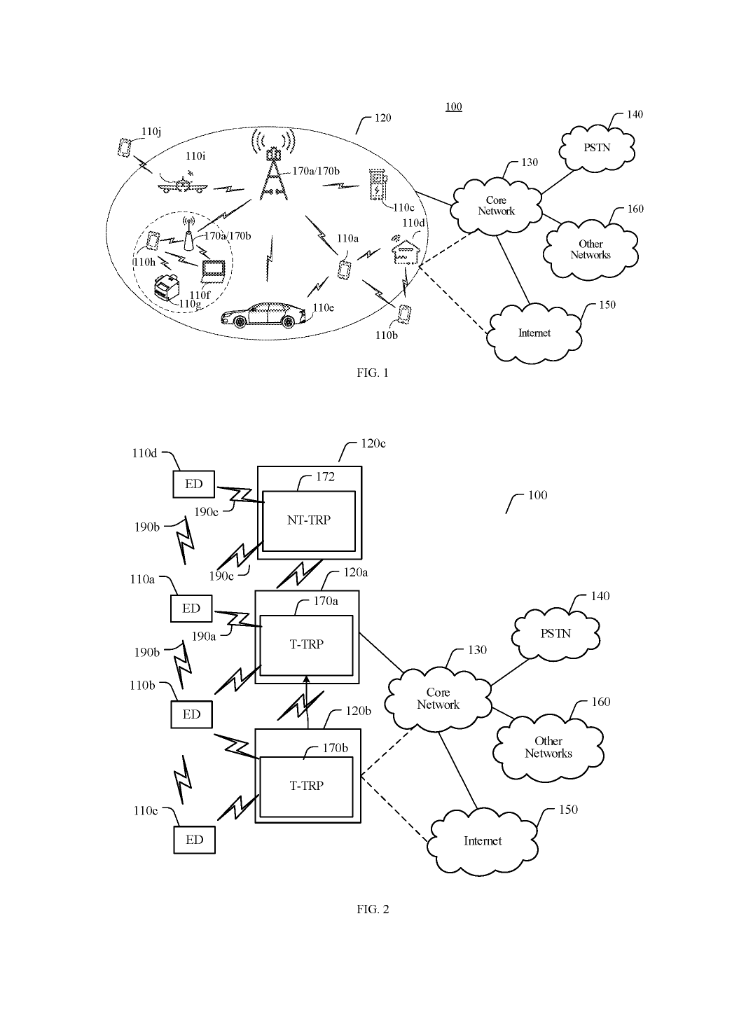

FIG. 1 is a simplified schematic illustration of a communication system according to one or more embodiments of the present disclosure. Referring to FIG. 1, as an illustrative example without limitation, a simplified schematic illustration of a communication system is provided. The communication system 100 includes a radio access network 120. The radio access network 120 may be a next generation (e.g. sixth generation (6G) or later) radio access network, or a legacy (e.g. 5G, 4G, 3G or 2G) radio access network. One or more communication electronic devices (ED) 110a, 110b, 110c, 110d, 110e, 110f, 110g, 110h, 110i, 110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 includes a public switched telephone network (PSTN) 140, the internet 150, and other networks 160.

FIG. 2 is a schematic illustration of an example communication system according to one or more embodiments of the present disclosure. FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast, groupcast, unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network including multiple layers. Compared to conventional communication networks, the heterogeneous network may achieve better overall performance through efficient multi-link joint operation, more flexible functionality sharing, and faster physical layer link switching between terrestrial networks and non- terrestrial networks.

The terrestrial communication system and the non-terrestrial communication system could be considered sub-systems of the communication system. In the example shown in FIG. 2, the communication system 100 includes electronic devices (ED) 110a, 110b, 110c, 110d (generically referred to as ED 110), radio access networks (RANs) 120a, 120b, a non-terrestrial communication network 120c, a core network 130, a public switched telephone network (PSTN) 140, the internet 150, and other networks 160. The RANs 120a, 120b include respective base stations (BSs) 170a, 170b, which may be generically referred to as terrestrial transmit and receive points (T-TRPs) 170a, 170b. The non-terrestrial communication network 120c includes an access node 172, which may be generically referred to as a non-terrestrial transmit and receive point (NT-TRP) 172.

Any ED 110 may be alternatively or additionally configured to interface, access, or communicate with any T-TRP 170a, 170b and NT-TRP 172, the internet 150, the core network 130, the PSTN 140, the other networks 160, or any combination of the preceding. In some examples, ED 110a may communicate an uplink and/or downlink transmission over a terrestrial air interface 190a with T-TRP 170a. In some examples, the EDs 110a, 110b, 110c, and 110dmay also communicate directly with one another via one or more sidelink air interfaces 190b. In some examples, ED 110d may communicate an uplink and/or downlink transmission over a non-terrestrial air interface 190cwith NT-TRP 172.

The air interfaces 190a and 190b may use similar communication technology, such as any suitable radio access technology. For example, the communication system 100 may implement one or more channel access methods, such as code division multiple access (CDMA), space division multiple access (SDMA), time division multiple access (TDMA), frequency division multiple access (FDMA), orthogonal FDMA (OFDMA), or single-carrier FDMA (SC-FDMA, also known as discrete Fourier transform spread OFDMA, DFT-s-OFDMA) in the air interfaces 190a and 190b. The air interfaces 190a and 190b may utilize other higher dimension signal spaces, which may involve a combination of orthogonal and/or non-orthogonal dimensions.

The non-terrestrial air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs 110 and one or multiple NT-TRPs 172 for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as internet protocol (IP), transmission control protocol (TCP), user datagram protocol (UDP). EDs 110a 110b, and 110c may be multimode devices capable of operation according to multiple radio access technologies, and incorporate multiple transceivers necessary to support such.

### Basic component structure

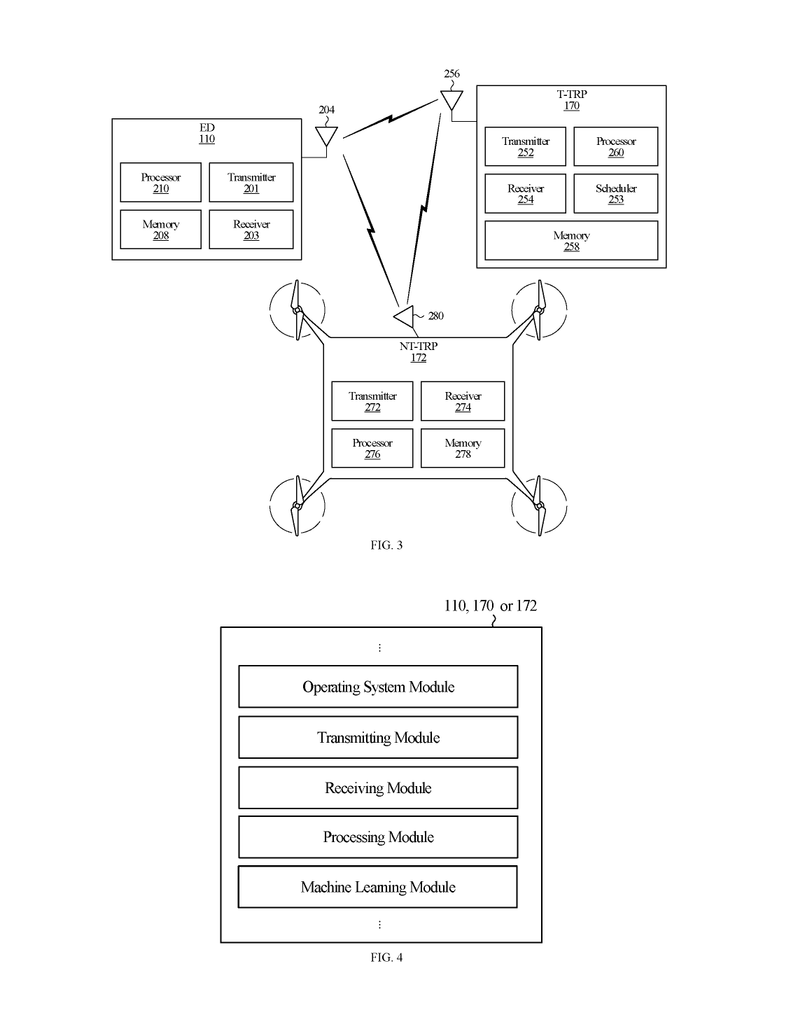

FIG. 3 is a schematic illustration of a basic component structure of a communication system according to one or more embodiments of the present disclosure. FIG. 3 illustrates another example of an ED 110 and a base station 170a, 170b and/or 170c. The ED 110 is used to connect persons, objects, machines, etc. The ED 110 may be widely used in various scenarios including, for example, cellular communications, device-to-device (D2D), vehicle to everything (V2X), peer-to-peer (P2P), machine-to-machine (M2M), machine-type communications (MTC), internet of things (IoT), virtual reality (VR), augmented reality (AR), mixed reality (MR), metaverse, digital twin, industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, wearable devices (such as a watch, a pair of glasses, head mounted equipment, etc.), an industrial device, or an apparatus in (e.g. communication module, modem, or chip) or including the foregoing devices, among other possibilities. Future generation EDs 110 may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated to avoid congestion in the drawing. One, some, or all of the antennas 204 may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by one or more processing unit(s) (e.g., a processor 210). Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices or interfaces permit interaction with a user or other devices in the network. Each input/output device or interface includes any suitable structure for providing information to or receiving information from a user, and/or for network interface communications. Suitable structures include, for example, a speaker, microphone, keypad, keyboard, display, touch screen, etc.

The ED 110 includes the processor 210 for performing operations including those operations related to preparing a transmission for uplink transmission to the NT-TRP 172 and/or the T-TRP 170; those operations related to processing downlink transmissions received from the NT-TRP 172 and/or the T-TRP 170; and those operations related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by the NT-TRP 172 and/or by the T-TRP 170. In some embodiments, the processor 210 implements the transmit beamforming and/or the receive beamforming based on the indication of beam direction, e.g. beam angle information (BAI), received from the T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or from the T-TRP 170.

Although not illustrated, the processor 210 may form part of the transmitter 201 and/or part of the receiver 203. Although not illustrated, the memory 208 may form part of the processor 210.

The processor 210, the processing components of the transmitter 201, and the processing components of the receiver 203 may each be implemented by the same or different one or more processors that are configured to execute instructions stored in a memory (e.g. in the memory 208). Alternatively, some or all of the processor 210, the processing components of the transmitter 201, and the processing components of the receiver 203 may each be implemented using dedicated circuitry, such as a programmed field-programmable gate array (FPGA), an application-specific integrated circuit (ASIC), or a hardware accelerator such as a graphics processing unit (GPU) or an artificial intelligence (AI) accelerator.

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a terrestrial node, a terrestrial network device, a terrestrial base station, a base band unit (BBU), a remote radio unit (RRU), an active antenna unit (AAU), a remote radio head (RRH), a central unit (CU), a distributed unit (DU), a positioning node, among other possibilities. The T-TRP 170 may be a macro BS, a pico BS, a relay node, a donor node, or the like, or combinations thereof. The T-TRP 170 may refer to the foregoing devices or refer to apparatus (e.g. a communication module, a modem, or a chip) in the foregoing devices.

In some embodiments, the parts of the T-TRP 170 may be distributed. For example, some of the modules of the T-TRP 170 may be located remote from the equipment that houses the antennas 256 for the T-TRP 170, and may be coupled to the equipment that houses the antennas 256 over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment that houses the antennas 256 of the T-TRP 170. The modules may also be coupled to other T-TRPs. In some embodiments, the T-TRP 170 may actually be a plurality of T-TRPs that are operating together to serve the ED 110, e.g. through the use of coordinated multipoint transmissions.

The T-TRP 170 includes at least one transmitter 252 and at least one receiver 254 coupled to one or more antennas 256. Only one antenna 256 is illustrated to avoid congestion in the drawing. One, some, or all of the antennas 256 may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to the NT-TRP 172, and processing a transmission received over backhaul from the NT-TRP 172. Processing operations related to preparing a transmission for downlink or backhaul transmission may include operations such as encoding, modulating, precoding (e.g. multiple input multiple output (MIMO) precoding), transmit beamforming, and generating symbols for transmission. Processing operations related to processing received transmissions in the uplink or over backhaul may include operations such as receive beamforming, demodulating received symbols, and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates an indication of beam direction, e.g. BAI, which may be scheduled for transmission by a scheduler 253. The processor 260 performs other network-side processing operations described herein, such as determining the location of the ED 110, determining where to deploy the NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Signaling may be transmitted in a physical layer control channel, e.g. a physical downlink control channel (PDCCH), in which case the signaling may be known as dynamic signaling. Signaling transmitted in a downlink physical layer control channel may be known as Downlink Control Information (DCI). Signaling transmitted in an uplink physical layer control channel may be known as Uplink Control Information (UCI). Signaling transmitted in a sidelink physical layer control channel may be known as Sidelink Control Information (SCI). Signaling may be included in a higher-layer (e.g., higher than physical layer) packet transmitted in a physical layer data channel, e.g. in a physical downlink shared channel (PDSCH), in which case the signaling may be known as higher-layer signaling, static signaling, or semi-static signaling. Higher-layer signaling may also refer to Radio Resource Control (RRC) protocol signaling or Media Access Control – Control Element (MAC-CE) signaling.

The scheduler 253 may be coupled to the processor 260. The scheduler 253 may be included within or operated separately from the T-TRP 170. The scheduler 253 may schedule uplink, downlink, sidelink, and/or backhaul transmissions, including issuing scheduling grants and/or configuring scheduling-free (e.g., “configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252, and the processing components of the receiver 254 may each be implemented by the same or different one or more processors that are configured to execute instructions stored in a memory, e.g. in the memory 258. Alternatively, some or all of the processor 260, the scheduler 253, the processing components of the transmitter 252, and the processing components of the receiver 254 may be implemented using dedicated circuitry, such as a programmed FPGA, a hardware accelerator (e.g., a GPU or AI accelerator), or an ASIC.

Although the NT-TRP 172 is illustrated as a drone only as an example, the NT-TRP 172 may be implemented in any suitable non-terrestrial form, it should be noted that the NT-TRP 172 may be removed in some cases. Also, the NT-TRP 172 may be known by other names in some implementations, such as satellites and high altitude platforms, including international mobile telecommunication base stations and unmanned aerial vehicles, for example. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated to avoid congestion in the drawing. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, demodulating received symbols, and decoding received symbols. In some embodiments, the processor 276 implements the transmit beamforming and/or receive beamforming based on beam direction information (e.g. BAI) received from the T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or part of the receiver 274. Although not illustrated, the memory 278 may form part of the processor 276.

The processor 276, the processing components of the transmitter 272, and the processing components of the receiver 274 may each be implemented by the same or different one or more processors that are configured to execute instructions stored in a memory, e.g. in the memory 278. Alternatively, some or all of the processor 276, the processing components of the transmitter 272, and the processing components of the receiver 274 may be implemented using dedicated circuitry, such as a programmed FPGA, a hardware accelerator (e.g., a GPU or AI accelerator), or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

### Basic module structure

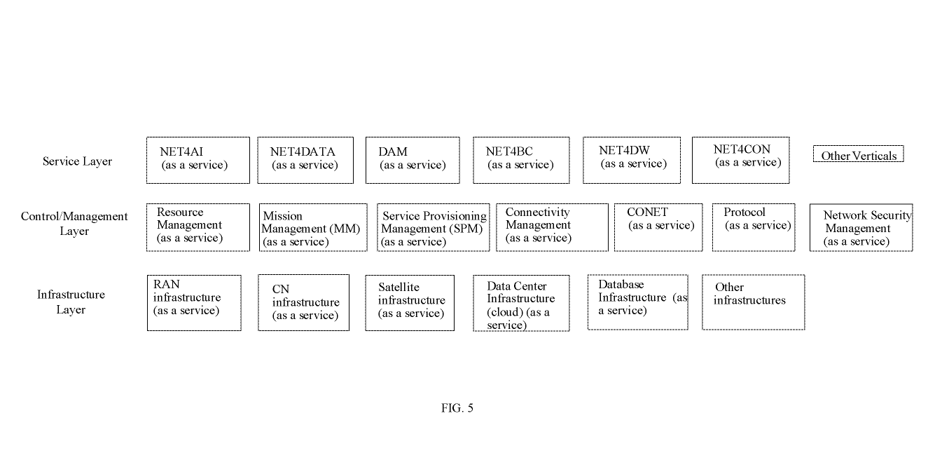

FIG. 4 illustrates a block diagram of a device in a communication system according to one or more embodiments of the present disclosure, as shown in FIG. 4, one or more steps of the embodiment methods provided herein may be performed by corresponding units or modules. FIG. 4 illustrates units or modules in a device, such as in the ED 110, in the T-TRP 170, or in the NT-TRP 172. For example, a signal may be transmitted by a transmitting unit or by a transmitting module. A signal may be received by a receiving unit or by a receiving module. A signal may be processed by a processing unit or a processing module. Other steps may be performed by an artificial intelligence (AI) or machine learning (ML) module, which can be chosen or removed according to actual requirements. The respective units or modules may be implemented using hardware, one or more components or devices that execute software, or a combination thereof. For instance, one or more of the units or modules may be a circuit such as an integrated circuit. Examples of an integrated circuit includes a programmed FPGA, a GPU, or an ASIC. For instance, one or more of the units or modules may be logical such as a logical function performed by a circuit, by a portion of an integrated circuit, or by software instructions executed by a processor. It will be appreciated that where the modules are implemented using software for execution by a processor for example, the modules may be retrieved by a processor, in whole or part as needed, individually or together for processing, in single or multiple instances, and that the modules themselves may include instructions for further deployment and instantiation. It should be noted that, the modules shown in FIG. 4 are only illustrative and should not be construed as limitations to the embodiments of the present disclosure, more or less modules may be included in the device, which is not limited here. For example, the transmitting module and the receiving module may be replaced with one transceiving module. For another example, the ML module can be included or excluded from the device, depending on actual needs.

Additional details regarding the EDs 110, the T-TRP 170, and the NT-TRP 172 are known to those of skill in the art. As such, these details are omitted here.

The solution described in the present disclosure may be applicable to a next generation (e.g. sixth generation (6G) or later) network, or a legacy (e.g. 5G, 4G, 3G or 2G) network.

The proposed 6G System architecture is defined to support 6G anything as a service (XaaS) services by using techniques such as Network Function Virtualization and Network Slicing. The 6G System architecture utilizes service-based interactions between 6G services.

The 6G System leverages service-based architecture and XaaS concept. XaaS services in the 6G System are categorized into three layers. FIG. 5 illustrates a block diagram of 6G System conceptual structure according to one or more embodiments of the present disclosure.

Infrastructure Layer includes infrastructures supporting 6G services. Among them are wireless networks (RAN, CN) infrastructures, Cloud/data center infrastructures, satellite networks, storage/database infrastructures, and sensing networks, and etc. These infrastructures can be provided by a single provider or by multiple providers.

Each of the infrastructures could have its control and management functions, denoted as (control and management) C/M functions, for infrastructure management. Each of these infrastructures is one type of Infrastructure as a Service.

Control and Management (C/M) layer includes control and management services of the 6G System. They are developed and deployed by using slicing techniques and utilizing resource provided by infrastructure layer. 6G services in Control and Management (C/M) layer are:

Resource Management (RM) as a Service provides a capability of life-cycle management of a variety of slices and over-the-air resource assignment to wireless devices.

Mission Management (MM) as a Service provides a capability to program provisioning of XaaS services at Service Layer to provide mission services.

Confederation Network (CONET) as a Service provides a capability to enable multiple partners jointly provide 6G services. This capability is provided by confederation formation, mutual authentication, mutual authorization among partners and negotiation of agreement on recording and retracing of selected actions performed by partners, in order to assure a trustworthy environment of 6G System operations.

Service Provisioning Management (SPM) as a Service provides a capability of control and management of 6G service access by customers and provisioning of requested services. The capability is provided by unified mutual authentication, authorization and policy, key management, QoS assurance and charging between any pair of XaaS service provider and customer. The customers include end-customers not only in physical world, but also digital representatives in digital world.

Connectivity Management (CM) as a Service leverages 5G connectivity management functions, but with extension to include digital world.

Protocol as a Service provides a capability to design service customized protocol stacks for identified interfaces. The protocol stacks could be pre-defined for on-demand selection, or could be on-demand designed.

Network Security as a Service provides a capability for owners of infrastructures to detect potential security risks of their infrastructures.

A 6G mission is defined as a service provided to customers by the 6G System. A mission can be a type of services which is provided by a single 6G XaaS service or a type of services that needs contributions from multiple XaaS services.

XaaS services in C/M Layer support control and management of the 6G System itself and also provide support to verticals if requested. One example is that RM service can serve RAN for over-the-air resource management and can also provide service to a vertical for the vertical’s over-the-air resource allocation to its end-customers. The XaaS in C/M layer can be deployed by using slicing technique.

Service Layer includes 6G services which provide services to customers. In the 6G System conceptual structure:

AI service may be denoted as NET4AI as a Service. Artificial Intelligence service provides AI capability to support a variety of AI applications.

Service of data collection, data sanitization, data analysis and data delivery are denoted as DAM as a Service, this service provides a capability of lifecycle management of statistic data, including acquisition, de-privatization, analysis and delivery of data which are information statistic data from any types of sensors, devices, network functions, and etc.

Service of storage and sharing of data may be denoted as NET4Data as a Service, this service provides a capability to trustworthily storage and share data under the control of owners of data and following recognized authorities’ regulations on control of identified data.

Service to provide digital world may be denoted as NET4DW as a Service, Digital World service provides a capability to construct, control and manage digital world. Digital world is defined as digital realization of physical world.

6G block chain service may be denoted as NET4BC as a Service. 6G connectivity service is denoted as NET4Con as a Service. This service provides a capability to support 6G block chain services.

Enhanced connectivity service, e.g., network for connectivity (NET4CON) as a service. This service provides a capability to support exchange of messages and data among new 6G services.

All XaaS services at this Layer are developed and deployed by using resource provided in infrastructure and utilizing Network Function Virtualization and Slicing techniques. The capability of each of 6G services is provided by its control and management functions and service specific data process functions.

In addition to support 6G XaaS services at Service Layer, 6G System leverages 5G System for provisioning of vertical services. The difference between 6G XaaS services and other verticals are that a vertical is a pure customer which needs other XaaS services to enable its operation, while each of XaaS services provide their capabilities to 6G customers.

Any pair of XaaS services of the 6G System could also be mutual customer and provider of each other. Some of examples are that an infrastructure owner provides its resource to XaaS services in Service Layer and C/M Layer; RM services may need the capabilities provided by NET4AI, DAM and NET4DW for its resource management for vertical slicing; CONET service and NET4Data service may need the capability provided by NET4BC for their operation.

The key concepts of 6G System includes:

Define Basic XaaS Services by decoupling comprehensive types of services into basic XaaS services. A basic XaaS service provides unique capability to enable a specific type of service, such as NET4AI service, NET4DW service, DAM service, NET4Data service, Block chain service, mission management service, etc.

Allow joint operation of the 6G System by multiple partners.

Define Data Plane of the 6G System which includes processing functions of data plane of XaaS services. Programing the interconnection of these functions, by mission management service, enables to support a variety of customized customer services.

Simplify 6G System architecture by categorizing basic control services and management services and combining them as basic XaaS services in Control and Management (C/M) Layer.

Define C/M Plane of the 6G System which includes C/M functions in XaaS services and may include 5G CP (e.g., AMF) depending on implementation options.

Define Basic Architecture Structure (BAS) which is a unified basic structure with minimized number of interfaces and is independent of types of infrastructures.

Simplify standardization, development and deployment of the 6G System using the BAS concept, while supporting a variety of infrastructure deployment scenarios.

Adapt to a variety of deployment scenarios by applying the BAS or a subset of it to infrastructures based on capability, capacity and requirement of the infrastructure networks.

Leverage service-based interface (SBI) concept and apply SBI interaction in both 6G C/M plane and 6G data plane.

Simplify SBI interfaces by introducing trustworthy GWs in Data Plane and C/M Plane of the 6G System.

Improve trustworthiness from perspectives of operation of the 6G System by introducing CONET capability, NET4BC capability and anonymous service provisioning provided by the trustworthy GWs in the C/M plane and data plane of the 6G System.

Improve trustworthiness from perspective of end customer privacy protection by unified mutual authentication, IDM, data sanitization and etc. provided by SPM service, DAM service and 6G Block Chain service.

Simplify roaming management of wireless devices, in physical world and digital world, by unified authentication including all participated partners and customers.

Support multiple development paths from 5G System to 6G System by defining multiple architecture options without incurring much efforts due to the introduction of the BAS concept.

Support backward compatibility by utilizing benefits of SBA and its add-on feature. 5G users can use the 6G System to access 5G services.

Support future extension by adding new XaaS services with minimized impact on standardization and deployment, due to the introduced anonymous service provisioning concept implemented in trustworthy GWs in 6G C/M plane and in 6G data plane.

Many new trends will trigger the consideration and design of 6G/future wireless networks:

New network infrastructure capability, e.g., cloud natured/friendly infrastructures that are broadly deployed.

New (relative) matured techniques, e.g., AI large scale models, Data de-privacy, Block chain, etc. that have made significant progresses and significantly impact on the entire society and human life.

New apps and services, e.g., AI services, Data (sensing) service, Digital world service, etc. that are broadly applied in industry/business and used by individual customers.

More global/open/collaborative operation trend, i.e., a more open and more collaborative operation mode are becoming common practice in many fields.

New expectation and stricter requirements on future networks also drive rethinking and development of new generation of wireless networks. These requirements include:

Privacy and trustworthiness, etc.

Simplified standardization.

Rapid deployment.

Etc.

All of the above drives 6G network architecture research work.

The proposed 6G network architecture (X-centric) are SBA (XaaS service) based and Cloud-native.

Requirements to 6G System network architecture design:

The proposed 6G network architecture needs to support new 6G services which could be developed/deployed by 3rd parties.

The proposed 6G network architecture needs to embrace more open ecosystem to open door to technical capable 3rd parties.

The proposed 6G network architecture needs to enable better trustworthiness management.

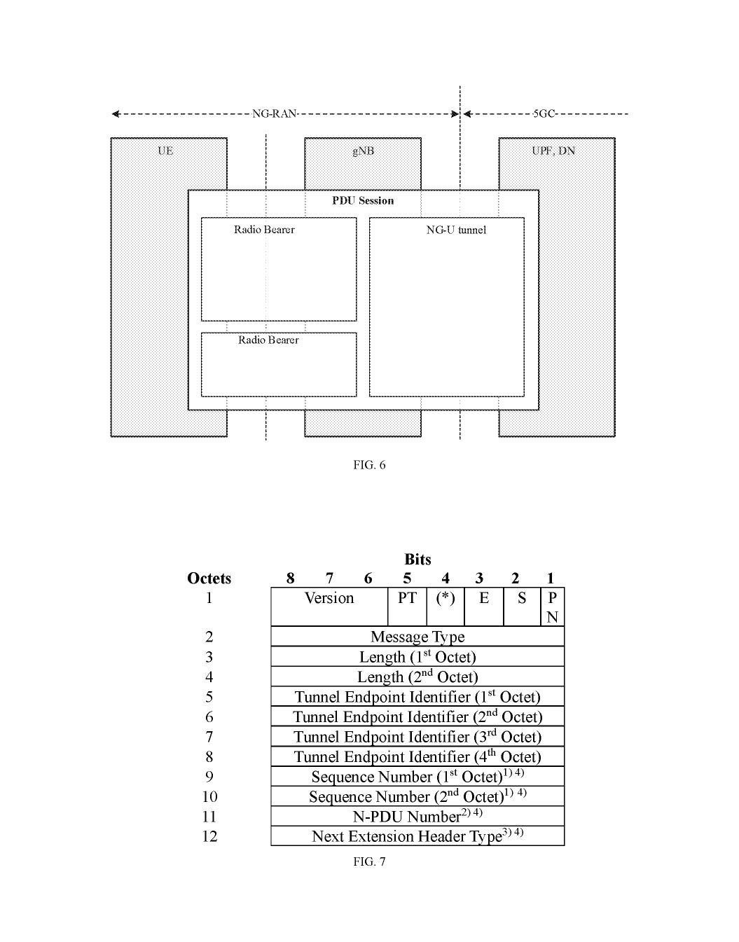

In the related art, a PDU connectivity service is provided by 5G network. The PDU connectivity service is a service that provides exchange of PDUs between user equipment (UE) and a data network (DN). 5G network provides the PDU connectivity service to a UE via one or more PDU sessions. FIG. 6 is a schematic illustration of 5G PDU session according to one or more embodiments of the present disclosure, as shown in FIG. 6, for a PDU session, it is an association between the UE and a data network (DN) that provides a PDU connectivity service. There are intermediate network nodes (e.g., RAN node gNB, user plane function (UPF)) in the PDU session between the UE and the DN. One or more QoS flows may be transmitted via a PDU session. The QoS Flow is the finest granularity of QoS differentiation in a PDU session. User Plane traffic within a QoS flow of a PDU session receives the same traffic forwarding treatment (e.g. scheduling, an admission threshold, delay, and a loss rate).

On the network side, user plane tunnels (e.g., GTP-U tunnel) are established to deliver data of a PDU session. For example, there are a NG-U tunnel (e.g., N3 tunnel) between a RAN and a UPF, a tunnel (e.g., N9 tunnel) between two UPFs, and a tunnel (e.g., N6 tunnel) between a UPF and a DN, etc. The data of a PDU session is delivered via the tunnels on network side.

To establish a PDU session for data forwarding, the 5G control plane functions (e.g., AMF, SMF, RAN CP) configures the user plane functions (e.g., a UPF, a RAN UP) to establish the resources for the PDU session, e.g., to establish tunnels (e.g., a GTP-U tunnel described in 3rd generation partnership project (3GPP) technical specification (TS 29.281)) on a network side. For example, a GTP-U tunnel (e.g., for N3 tunnel, N9 tunnel) is established per PDU session, and a GTP-U tunnel is dedicated to a PDU session. For example, a GTP-U tunnel between a RAN and a UPF in 5G is established dedicatedly for a PDU session. For a downlink packet on a user plane, when the RAN receives a packet from a configured tunnel of a PDU session, the RAN can distinguish that the packet belongs to the PDU session. Similarly, for an uplink packet on the user plane, when a UPF receives a packet from a configured tunnel of a PDU session, the UPF can distinguish that the packet belongs to the PDU session.

The QoS flow is the finest granularity of QoS differentiation in a PDU session. A QoS flow ID (QFI) is used to identify a QoS flow in the 5G System. User Plane traffic with the same QFI within a PDU session receives the same traffic forwarding treatment (e.g. scheduling, and an admission threshold). The QFI is carried in an encapsulation header on a packet transmitted through a N3 tunnel (or through a N9 tunnel) i.e. without any changes to the end to end packet header. QFI shall be used for all PDU session types. The QFI shall be unique within a PDU session. The QFI may be dynamically assigned or may be equal to the 5G QoS identifier (5QI). A QoS flow is associated with QoS requirements as specified by QoS parameters and QoS characteristics.

To enable a user plane network entity (e.g., a UPF, a RAN) to detect and distinguish which QoS flow a packet received from a tunnel of a PDU session belongs to, additional information (e.g., a PDU session container) are encapsulated into a GTP-U packet, as described in 3GPP TS 29.281 and TS 38.415.

GTP-U Tunnels are used to carry encapsulated transport PDU (T-PDUs) and signaling messages between a given pair of GTP-U tunnel endpoints. The tunnel endpoint ID (TEID) which is present in the GTP header shall indicate which tunnel a particular T-PDU belongs to. In this manner, packets are multiplexed and de-multiplexed by GTP-U between a given pair of tunnel endpoints. The TEID value to be used in the TEID field shall be signaled to the peer GTP-U entity using a control plane protocol.

FIG. 7 is a schematic illustration of an outline of a GTP-U packet header according to one or more embodiments of the present disclosure. Referring to FIG. 7:

Tunnel endpoint identifier (TEID): this field unambiguously identifies a tunnel endpoint in the receiving GTP-U protocol entity. The receiving end side of a GTP tunnel locally assigns the TEID value which the transmitting side has to use. The TEID value may be assigned in a non-predictable manner.

Extension header flag (E): This field indicates a presence of a meaningful value of the Next Extension Header field. When it is set to '0', the Next Extension Header field either is not present or, if present, shall not be interpreted. When it is set to '1', the next extension header field is present, and shall be interpreted.

Next extension header type: This field defines a type of an Extension Header that follows this field in the GTP-PDU.

The meanings and uses of other fields in the GTP-U header of FIG. 7 could be found in 3GPP TS 29.281 and TS 38.415, which are omitted here.

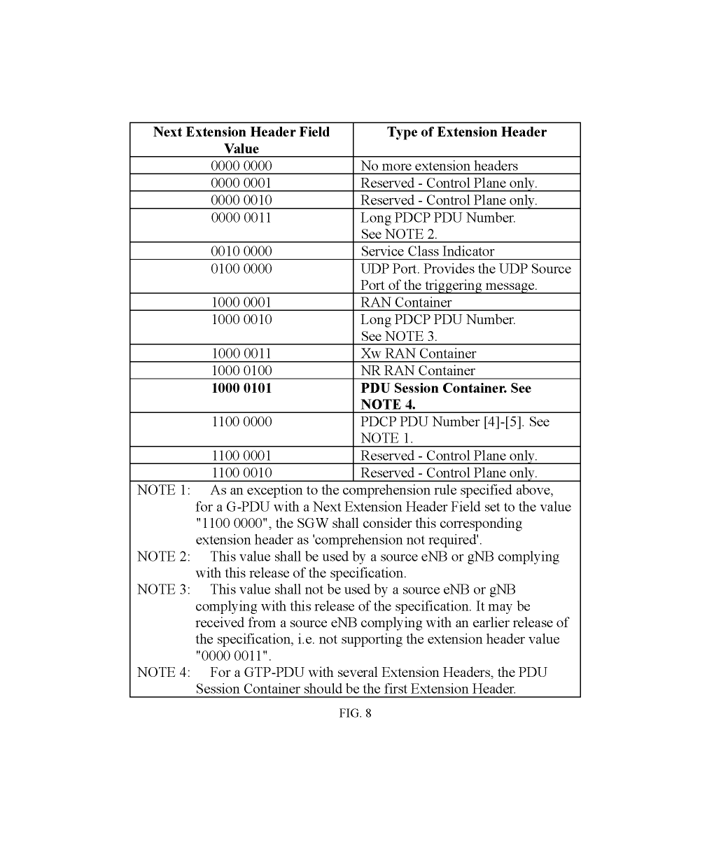

FIG. 8 is a schematic illustration of definitions of extension header types according to one or more embodiments of the present disclosure. Definition of extension header types are depicted in FIG. 8. There is a type of extension header for PDU session container, e.g., indicated with value of the next extension header field being 10000101.

FIG. 9 is a schematic illustration of a format of a GTP-U extension header according to one or more embodiments of the present disclosure. The format of a GTP-U extension header is depicted in FIG. 9.

The extension header length field specifies a length of a particular extension header. The next extension header type field specifies a type of any extension header that may follow the particular extension header. If no such header follows, a value of the next extension header type shall be 0.

There is a PDU session container encapsulated in a GTP-U packet header when the type of extension header is set to PDU session container (e.g., with a value of the next extension header field being set to 10000101). This PDU session container extension header could be transmitted over a N3 tunnel and/or a N9 tunnel via user plane interfaces, between a RAN and a UPF, or between two UPFs.

A length of the PDU session container is variable, and a content of the PDU session container is specified, e.g., in 3GPP TS 38.415.

In some cases, the PDU session user plane protocol data is conveyed by GTP-U protocol means, more specifically, by means of the "PDU session container" in a GTP-U extension header.

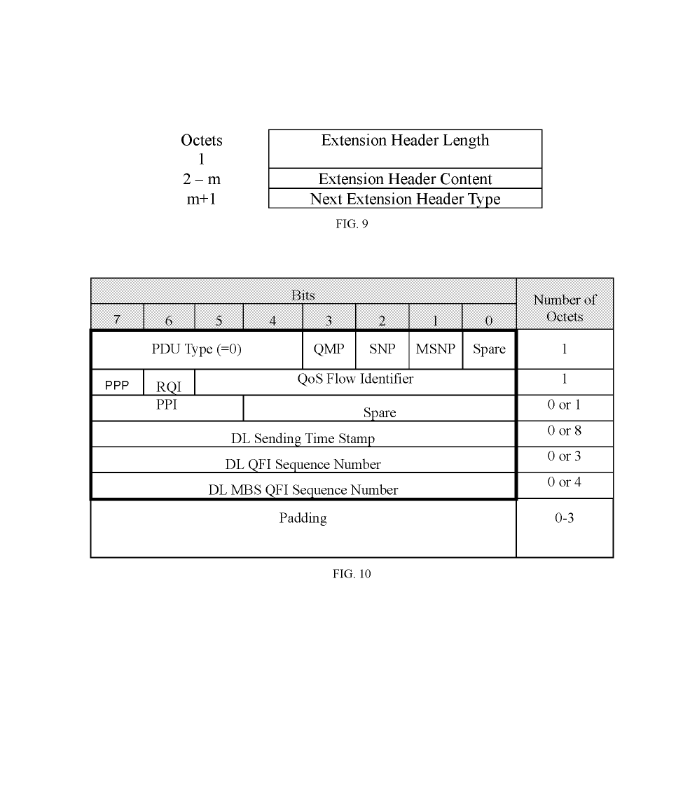

FIG. 10 is a schematic illustration of a format of downlink (DL) PDU session information according to one or more embodiments of the present disclosure. DL PDU session information can be conveyed by GTP-U protocol means, more specifically, by means of the "PDU session container" in a GTP-U extension header as shown in FIGS. 8 and 9. The DL PDU session information is an implementation example of a PDU session container content.

In some cases, a format of downlink (DL) PDU session information for a PDU session user plane protocol is depicted in FIG. 10, the DL PDU session information is conveyed by means of PDU session container, e.g., in a GTP-U extension header. It can be conveyed between a RAN node and a UPF, between UPFs, between RAN nodes, or between other network entities. The DL PDU session information may also be named as a DL PDU session information frame.

A DL PDU session information frame includes a QoS flow identifier (QFI) field associated with the transferred packet. A network entity (e.g., a RAN node) may use a received QFI to determine a QoS flow and a QoS profile which are associated with the received packet. For example, when a network entity (e.g., a RAN node, a UPF) receives a packet from a GTP-U tunnel of a PDU session, the network entity can detect and distinguish which QoS flow the packet belongs to, based on the QFI included in the PDU session container (conveying the PDU session information).

The DL PDU session information frame may include a reflective QoS indicator (RQI) field to indicate whether a user plane reflective QoS may be activated or not.

The meanings and uses of the other fields in the DL PDU session information frame of FIG. 10 could be found in 3GPP TS 29.281 and TS 38.415, which are omitted here.

FIG. 11 is a schematic illustration of a format of uplink (UL) PDU session information according to one or more embodiments of the present disclosure. UL PDU session information can be conveyed by GTP-U protocol means, more specifically, by means of the "PDU session container" in a GTP-U extension header as shown in FIGS. 8 and 9. The UL PDU session information is an implementation example of a PDU session container content.

In some cases, a format of Uplink (UL) PDU session information for a PDU session user plane protocol is depicted in FIG. 11, the UL PDU session information is conveyed by means of PDU session container, e.g., in a GTP-U extension header. It can be conveyed between a RAN node and a UPF, between UPFs, between RAN nodes, or between other network entities. The UL PDU session information may also be named as a UL PDU session information frame.

A UL PDU session information frame includes a QoS flow identifier (QFI) field associated with the transferred packet. A network entity (e.g., a RAN node) may encapsulate a QFI to enable a peer node to determine a QoS flow and a QoS profile which are associated with the packet. For example, when a network entity (e.g., a RAN node, a UPF) sends a packet via a GTP-U tunnel of a PDU session, the network entity can enable the peer node to detect and distinguish which QoS flow the packet belongs to, based on the QFI encapsulated in the PDU session container (conveying the PDU session information).

If QoS monitoring has been requested for the included QFI field, the UL PDU session information frame may include a QoS monitoring packet (QMP) field, a DL sending time stamp repeated field, a DL receiving time stamp field, a UL sending time stamp field, and/or a delay result for UL or DL.

The meanings and uses of the other fields in the DL PDU session information frame of FIG. 11 could be found in 3GPP TS 29.281 and TS 38.415, which are omitted here.

User plane functions (e.g., a UPF, a RAN UP) performs suitable actions to deliver uplink and/or downlink data. For example, UPF classifies PDU layer packets for QoS flow marking (e.g., based on packet detection rule) and maps the QoS flows to GTP-U tunnels. And other user plane function (e.g., UPF, RAN) decides the QoS flow to which a received packet belongs, based on the QoS flow identifier (ID) marked in the packet header, and decides the PDU session to which a received packet belongs, based on the tunnel via which the packet is delivered. RAN maps QoS flows of a PDU session received in a specific GTP-U tunnel to data radio bearers.

However, for a next generation (e.g. sixth generation (6G) or later) network, or a legacy (e.g. 5G, 4G, 3G or 2G) network in 6G era, the 6G network is expected to not only for connectivity, but also for data processing. Thus, in 6G era, in-network data processing (computing) is supported.

In order to achieve the above objectives, a mission service is designed for 6G network. A mission is to achieve a designated goal, known as mission goal, which includes (1) providing PDU connectivity and optionally (2) providing data processing. A mission service is a service that provides achieving of a mission goal (i.e., PDU connectivity and/or data processing). When the mission goal includes providing data processing, the mission goal is associated with specific computational problem(s), and providing data processing refers to solving the specific computational problem(s). In this case, the mission includes one or multiple computing blocks (CBs) and is associated with a networking procedure among the CBs for solving the specific computational problem(s). A CB within the mission corresponds to a defined computational step toward the mission goal (i.e. solving the specific computational problem(s)) and may be executed by a function of XaaS service (in the form of a task), by a data network (DN), or by a function of another mission service; accordingly, the CB is referred to as a task CB, an external CB or a sub-mission CB. A CB corresponds to a particular action of data processing, e.g., AI training, AI inference, data pre-processing, data de-privatization, data cleaning, data collection, data analytics, sensing, etc. Different CBs of a mission may be executed in sequence or parallel.

When the mission goal only includes providing PDU connectivity, the mission service may be reduced to a 5G PDU connectivity service. When the mission goal includes providing data processing, data is forwarded to one or more CB entities and processed by the CB entities, then processed data is forwarded to a next-hop, such as, another one or more CB entities, until the mission goal is completed.

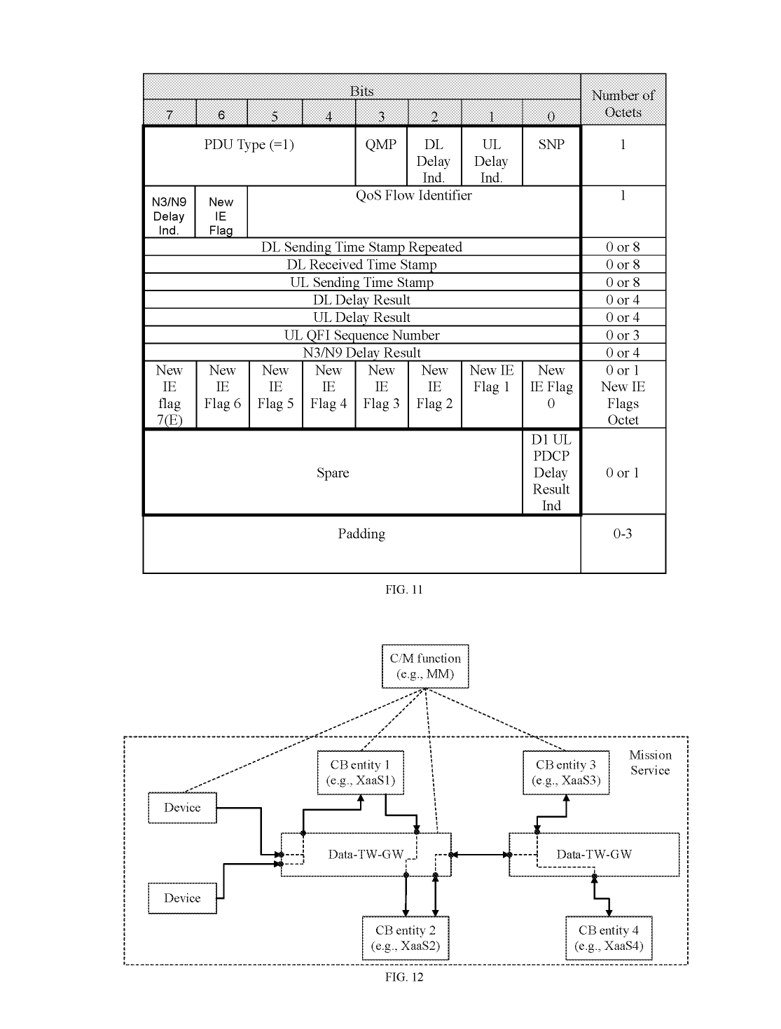

FIG. 12 is a schematic illustration of a mission service provided by a 6G network according to one or more embodiments of the present disclosure. As shown in FIG. 12, each of the CB entities executing one or more CBs. The CB entities can be deployed in a device (e.g., a UE, a vehicle, a radar, a sensor, a drone, and an actuator), a RAN, a CN, and even in a DN. In some cases, the CB entities are deployed on functions of XaaS services. The functions of XaaS services may be in a device, a RAN, a CN and a DN. In some cases, the mission service including the CB entities is configurable and under the control of C/M plane functions, e.g., a mission management function (MM). As in FIG. 12, devices deploying CB entities and other CB entities provided by functions of XaaS services are involved in a mission service to perform data processing in parallel and/or sequence. The functions of XaaS services can be in one or more of: RAN, CN and DN. For example, CB entities 1, 2, 3 and 4 are provided by functions of XaaS services 1, 2, 3 and 4, respectively, and the two devices may also provide other CB entities (not illustrated in the figure) or not. In some cases, the CB entities 1, 2, 3 and 4 may be provided by one or more functions of a same XaaS service instead of 4 different functions of XaaS services. In some cases, zero, one or more of the 4 CB entities are in the DN, and the other CB entities are in one or more of: RAN, and CN. The CB entities and devices are connected via data trustworthy gateway (Data-TW-GW). In some cases, the CB entity, Data-TW-GW are deployed on 6G data plane, and the data plane may be also termed as user plane, or enhanced user plane, etc. In some cases, the Data-TW-GW could be UPF, or enhanced UPF. CB entities (e.g., deployed in a device, a RAN, a CN, a DN and third parties) are connected via Data-TW-GW. The Data-TW-GW is helpful to get rid of mesh topology among CBs and to support anonymous communication among CBs. The Data-TW-GW can also be referred to as a GW entity.

For the data processing (computing) procedure within the mission service:

the two devices may deliver data (non-processed or processed data by CB entities in the devices) to CB entity 1 being provided by a function of XaaS service 1 (e.g., Data Analytics and Management (DAM) service);

CB entity 1 delivers the data directly or deliver the data after processing to CB entity 2 being provided by a function of XaaS service 2 (e.g., NET4AI service), via Data-TW-GW 1;

in parallel, CB entity 2 receives data from CB entity 4 being provided by a function of XaaS service 4 (e.g., NET4DW service), via Data-TW-GW 1 and Data-TW-GW 2;

and the data received by CB entity 2 from CB entity 4 is the processed results of the data received by CB entity 4 from CB entity 3 being provided by a function of XaaS service 3 (e.g., NET4Data), via Data-TW-GW 2;

then CB entity 2 performs data processing of AI training (or AI inference, etc.) using all the received data from CB entities 1, 3 and 4, and sends the processed results to CB entity 4;

CB entity 4 perform data processing using the data sent by CB entity 2 and the data from CB entity 3, and sends the processed results to CB entity 2; and then, back and forth data processing and forwarding are performed among CB entities 2, 3 and 4 until the mission goal is completed.

In some case, a mission corresponds to a service function chain as defined by internet engineering task force (IETF), e.g., in request for comments (RFC) 7665. A service function chain is defined as a logical representation of an ordered set (sequence) of service functions that need to successively handle some traffic, e.g. traffic is first handled by service function 1 (e.g. deep packet inspection), then service function 2 (e.g. TCP/IP optimization) and lastly by service function 3 (e.g. firewall).

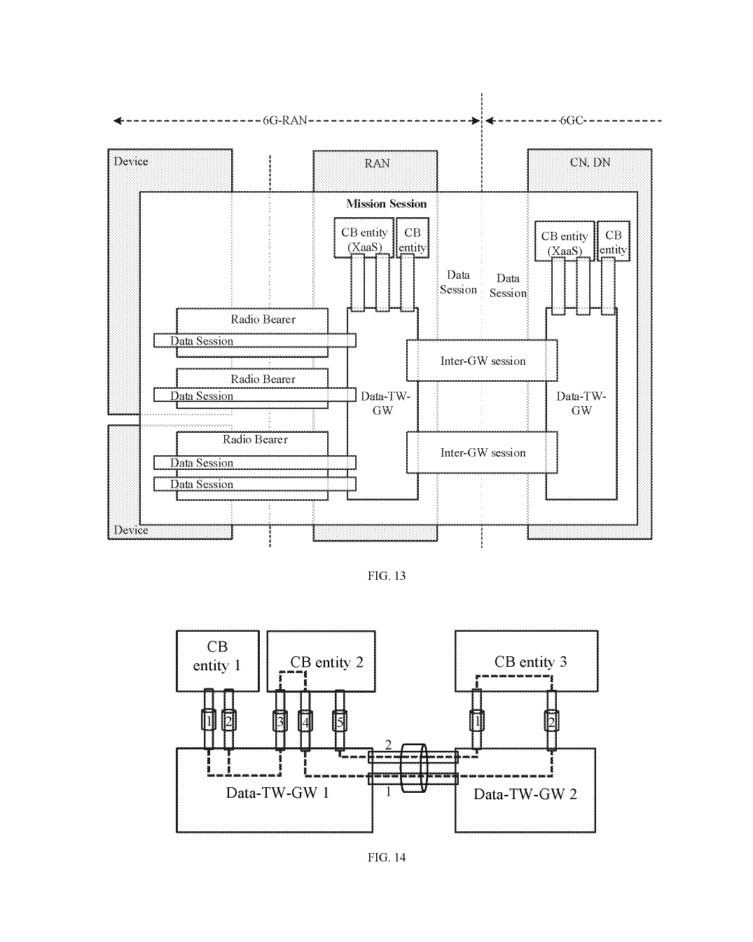

FIG. 13 is a schematic illustration of a mission session for a mission service according to one or more embodiments of the present disclosure. As in FIG. 13, a mission service subscriber (e.g., 6G device, AS) accesses a mission service via one or multiple mission sessions.

The mission session is to provide a mission service to a mission customer, and the mission service is a service for both protocol data unit (PDU) connectivity and data processing. In some cases, the mission service subscriber may also be referred to as a mission customer, which requests to access to the mission service.

Specifically, the mission session is an association between a network entity (e.g. UE, a network function (NF), and an AS) and a data network (DN), providing a mission service. And the DN may be virtual and dummy DN. A mission session includes the data forwarding and data processing resources to execute a mission. A mission session includes a collection (group) of data sessions and optional inter-GW sessions.

The mission service is a service that provides achieving of a mission goal (i.e., PDU connectivity and/or data processing). When the mission goal includes providing data processing, the mission goal is associated with specific computational problem(s), and providing data processing refers to solving the specific computational problem(s). In this case, the mission includes one or multiple computing blocks (CBs) and is associated with a networking procedure among the CBs for solving the specific computational problem(s). A CB within the mission corresponds to a defined computational step toward the mission goal (i.e. solving the specific computational problem(s)). In some cases, a CB is executed by a function of XaaS service (in the form of a task), by a data network (DN), or by a function of another mission service; accordingly, the CB is referred to as a task CB, an external CB or a sub-mission CB. A CB corresponds to a particular action of data processing, e.g., AI training, AI inference, data pre-processing, data de-privatization, data cleaning, data collection, data analytics, sensing, etc. Different CBs of a mission may be executed in sequence or parallel.

The mission session includes one or more data sessions, each data session includes an association that terminates at a computing block (CB) entity executing at least one CB of a mission, the mission includes one or more CBs and each CB corresponds to a computational step toward achieving the mission service. The data processing includes the executing the at least one CB of the mission. The computational step toward achieving the mission service can also be referred to as the computational step toward the mission goal cited above.

The mission session includes one or more data sessions, the one or more data sessions are used to deliver data of the one or more CBs, and the establishing either or both of the PDU connectivity resource and the data processing resource for the mission session includes establishing at least one of the one or more data sessions, where each data session includes an association terminates at one CB entity, one CB entity participates in one or more data sessions, and one CB entity participates in one or more mission sessions. The PDU connectivity resource can also be called the data forwarding resource cited above.

Furthermore, the CB entity is for executing at least one CB of a mission, the mission includes one or more CBs and each CB corresponds to a computational step toward achieving the mission service; where the data processing includes the executing the at least one CB of the mission.

Among them, the computational step toward achieving the mission service includes one or more of: artificial intelligence (AI) training, AI inference, data pre-processing, data privacy protection, data cleaning, data collection, data analytics, sensing, data sanitization, data management, data normalization, data aggregation, data splitting, useless data filtering, data formatting, data adaptation, data feature engineering, data compression, data embedding, data representation learning, or data feature extraction.

Specifically, the data session is an association at least terminates at a computing block (CB) entity to execute one or more CBs of a mission. The CB entity is an entity to execute the actions corresponding to the one or more CBs. Particular data transmission and/or data processing are executed among the CB entities in specific order (e.g., in sequence and/or parallel) to complete the mission. The CB entity is a network entity which can be deployed in: device (e.g., UE, vehicle, radar, sensor, drone, and actuator), RAN, CN, and DN. In some cases, the CB entity is deployed on function of XaaS service. The function of XaaS service can be in a device, a RAN, a CN and a DN. In some cases, the CB entity is deployed on 6G data plane. In some cases, the CB entity is supported by a XaaS service, e.g., by a processing service function (PSF) of the XaaS service. Different CB entities may execute the same or different CBs. In some cases, a data session corresponds to one CB of a mission. In some cases, a data session corresponds to multiple CBs of a mission. In some cases, the CB entity may also be named as a CB DP entity.

In some cases, the data session may be regarded as only including the data forwarding resource for supporting the executing of one or more CBs of a mission, i.e., a pipe to connect a CB entity with another network entity, and the data processing resources configured in the CB entity do not belong to the data session.

In some cases, the data session may be regarded as including both of the data forwarding and data processing resources to execute one or more CBs of a mission, i.e., the data processing resources configured in the CB entity also belongs to the data session.

The data sessions includes one of: an association between a CB entity and a GW entity, or an association between a CB entity and another CB entity.

Specifically, a data session is an association between a CB entity and a Data-TW-GW; or a data session is an association between a CB entity and another CB entity.

Furthermore, when a data session includes the association between the CB entity and the GW entity, the CB entity and the GW entity are involved in one or multiple data sessions, and the CB entity and the GW entity are involved in one or multiple mission sessions.

In some cases, for implementation, a data session is an association between a device (e.g., UE, a vehicle, a radar, a sensor, a drone, and an actuator) deployed with a CB entity and a Data-TW-GW. The Data-TW-GW may be deployed in a RAN or a CN.

In some cases, for implementation, a data session is an association between a Data-TW-GW and a processing service function (PSF) of a XaaS service, and a CB entity is deployed on the PSF. The Data-TW-GW may be deployed in a RAN or a CN. The PSF may be deployed in a RAN or a CN.

In some cases, for implementation, a data session is an association between a device and a PSF of a XaaS service. The PSF may be deployed in a RAN or a CN.

In some cases, for implementation, a data session is an association between a PSF and another PSF, and the two PSFs may be functions of a same or different XaaS services. Both or either of the two PSFs may be deployed in a RAN or a CN.

In some cases, for implementation, a data session is an association between a DN and a PSF of a XaaS service. The PSF may be deployed in a RAN or a CN.

In some cases, for implementation, a data session is an association between a DN and a Data-TW-GW. The Data-TW-GW may be deployed in a RAN or a CN.

In some cases, for implementation, a data session is an association between two devices.

In some cases, for implementation, a data session is an association between two DNs.

In some cases, for implementation, a data session is an association between a device and a DN.

The mission session further includes one or more inter-gateway (GW) sessions, each inter-GW session includes an association between two GW entities, and each GW entity is used for supporting communication among CB entities.

The mission session includes one or more data sessions and/or one or more inter-GW sessions, the one or more data sessions and/or one or more inter-GW sessions are used to deliver data of the one or more CBs, at least one of the one or more data sessions and the one or more inter-GW sessions terminates at the GW entity, and the GW entity is used for supporting communication among CB entities, and the establishing either or both of the PDU connectivity resource and the data processing resource for the mission session includes establishing at least one of: the one or more data sessions and one or more inter-GW sessions; where each data session includes an association terminates at one CB entity, each inter-GW session includes an association between two GW entities, one GW entity participates in at least one of: the one or more data sessions and the one or more inter-GW sessions, and one GW entity participates in one or more mission sessions.

Specifically, the inter-GW session is an association between two Data-TW-GWs for data forwarding. In some cases, the Data-TW-GW could be UPF, or enhanced UPF. CB entities (e.g., deployed in a device, a RAN, a CN and a DN) are connected via Data-TW-GW. The Data-TW-GW is helpful to get rid of mesh topology among CBs and to support anonymous communication among CBs.

A CB entity (deployed in a device, a RAN, a CN or a DN) may participate into one or multiple mission sessions. A CB entity may participate into one or multiple data sessions.

A mission session can be identified by a mission session ID or a session group ID. A data session can be identified by a data session ID.

As shown in FIG. 13, a mission session includes of one or multiple data sessions. There are two CB entities deployed in a RAN, two CB entities deployed in core network functions (NFs) or a DN. Devices may also deploy CB entities or be active as CB entities not illustrated in the figure. The CB entity may be supported by a function of XaaS service. Over the air, radio bearer is established between device and 6G RAN node. The data session is established between a device deploying a CB entity and a Data-TW-GW. Each device establishes one or multiple data sessions belongs to a mission session. One or multiple devices are involved in a mission session. Flexible mapping are enabled between a radio bearer and a data session. On network side, a data session is established between a CB entity and a Data-TW-GW. There could be one or multiple data sessions between a CB entity and a Data-TW-GW, and a CB entity (e.g., deployed in PSF of XaaS) could participate into one or multiple data sessions. A CB entity (e.g., deployed in PSF of XaaS) could participate into one or multiple mission sessions. One or multiple inter-GW sessions are established between Data-TW-GWs. As in FIG. 13, two devices are involved in a mission session, and each device establishes two data sessions. A data session may be mapped to a radio bearer, or multiple data sessions are mapped to a radio bearer. It does not rule out the possibility that a data session is mapped to multiple radio bearers. One of the two CB entities in a RAN establishes 2 data sessions illustrated as small rectangular boxes, another one of the two CB entities in the RAN establishes 1 data session. One CB entity in NFs or a DN establishes 2 data sessions, and one CB entity in the NFs or the DN establishes 1 data session. Two inter-GW sessions are established between the two Data-TW-GWs.

A mission includes no CBs (i.e. no computing-related functionalities) when its goal is only to provide PDU connectivity. In this case, a mission session is reduced to a PDU session. Different mission session types can be defined: PDU connectivity only type, and both data connectivity and processing type (i.e., non PDU connectivity only type). The PDU connectivity only type indicates that no CB entity is involved in the mission session, i.e., the mission session is reduced to a PDU session in this case. In this case, the mission service is reduced to a service for PDU connectivity only. The both data connectivity and processing type (i.e., non PDU connectivity only type) indicates that there is at least one CB entity involved in the mission session, both data forwarding and processing are supported via the mission session, e.g., to support 6G services of data processing (e.g., AI, sensing, data service).

In some cases, the CB entity of a mission session is a virtual and dummy entity, e.g., for a mission session of PDU connectivity only type.

Furthermore, for the PDU connectivity only type, there is no data session belonging to the mission session, all data sessions belong to the mission session are dummy data sessions.

In the present disclosure, the terms forward (forwarding), transmit (transmission) and deliver (delivery) are used interchangeably. Data connectivity and data forwarding are used interchangeably.

Similarly, one inter-GW session corresponds to one or more QoS flows, and data traffics of the one or more QoS flows are delivered via the inter-GW session, where a QoS flow is a finest granularity of QoS differentiation in the mission service, and a data traffic within a QoS flow receives same data processing treatment and same data forwarding treatment. In addition, one inter-GW session is implemented as one QoS flow or one PDU session.

For example, one or multiple QoS flows are delivered in a data session. QoS flow is the finest granularity of QoS differentiation in the mission service. Traffic within the same QoS flow receives the same data processing treatment and data forwarding treatment. In some cases, a data session is implemented as a QoS flow.

New radio bearers dedicated for mission service may be established over the air on C/M plane and data plane to provide service with particular QoS. For example, new data radio bearer dedicated for a mission session is established over the air on data plane to provide service with particular QoS.

Different data sessions of a mission session may be mapped and connected via one or more Data-TW-GWs, e.g., depending on whether, and how many Data-TW-GWs are deployed.

Different data sessions of a mission session may be mapped and connected internally within a CB entity.

FIG. 14 is a schematic illustration of tunnels configured per data (inter-GW) session according to one or more embodiments of the present disclosure, as shown in FIG. 14, a rectangular represents a data session or an inter-GW session of a mission session, and a cylindrical represents a tunnel dedicatedly configured for a data session or an inter-GW session of the mission session. The tunnel is configured per data session for a mission session and cannot be shared by different data sessions or inter-GW sessions between two network entities. The type of the tunnel is not limited to a GTP-U tunnel, a quick user datagram protocol (UDP) internet connections (QUIC) connection, etc. Hereinafter, the term of “QUIC connection” also may be referred to as a tunnel. CB entity 1 establishes data sessions 1 and 2 with Data-TW-GW 1. CB entity 2 establishes data sessions 3, 4 and 5 with Data-TW-GW 1. CB entity 3 establishes data sessions 1 and 2 with Data-TW-GW 2. There are inter-GW sessions 1 and 2 established between Data-TW-GW 1 and Data-TW-GW 2. Seven tunnels are established each of which is dedicated for a data session, and two tunnels are established each of which is dedicated for an inter-GW session. As illustrated by the dash line, data sessions 1 and 2 of CB entity 1 are mapped to data session 3 of CB entity 2 via Data-TW-GW 1, data session 3 of CB entity 2 is mapped to data session 4 of CB entity 2 within CB entity 2, data session 4 of CB entity 2 is mapped to inter-GW session 1 via Data-TW-GW 1, inter-GW session 1 is mapped to data session 2 of CB entity 3 via Data-TW-GW 2, data session 2 of CB entity 3 is mapped to data session 1 of CB entity 3 within CB entity 3, data session 1 of CB entity 3 is mapped to inter-GW session 2 via Data-TW-GW 2. For example, CB entity 1 executes CB 1 and CB 2 corresponding to data session 1 and data session 2, respectively. CB entity 1 sends the data processing results of CB 1 and CB 2 (corresponding to data session 1 and data session 2, respectively) to data session 3 of CB entity 2 via Data-TW-GW 1. CB entity 2 executes CB 3 to using the received data from CB entity 1 and then sends the new data processing results to CB entity 1. Back and forth data forwarding and data processing are performed between CB entity 1 and CB entity 2 until CB 1 and CB 2 of CB entity 1 and CB 3 of CB entity 2 are completed. Then CB entity 2 sends the final data processing results of CB 3 to data session 4 of CB entity 2. CB entity 2 executes CB 4 corresponding to data session 4 and sends data processing results to data session 2 of CB entity 3 via Data-TW-GW 1 and Data-TW-GW 2 through inter-GW session 1. CB entity 3 executes CB 6 corresponding to data session 2. Back and forth data forwarding and data processing are performed between CB entity 2 and CB entity 3 until CB 4 of CB entity 2 and CB 6 of CB entity 3 are completed. Then CB entity 3 sends the final data processing results of CB 6 to data session 1 of CB entity 3. CB entity 3 executes CB 7 corresponding to data session 1 and sends data processing results to data session 5 of CB entity 2 via Data-TW-GW 2 and Data-TW-GW 1 through inter-GW session 2. CB entity 2 executes CB 5 corresponding to data session 5. Back and forth data forwarding and data processing are performed between CB entity 3 and CB entity 2 until CB 5 of CB entity 2 and CB 7 of CB entity 3 are completed. Then the mission may be completed. It can be observed that, some data from CB entity 2 should be sent to CB entity 1 via Data-TW-GW 1, and some data from CB entity 2 should be sent to CB entity 3 via Data-TW-GW 1. In order to enable the CB entities and the Data-TW-GWs to deliver data in specific sequence of CBs of a mission via suitable tunnel, and to enable them to detect and recognize the packet received via a tunnel, data forwarding information, e.g., data mapping information and tunnel information, should be configured to the CB entities and Data-TW-GWs, and data processing information, e.g., CB sequence, should be configured to the CB entities.

In some cases, CB entity 1, CB entity 2 and Data-TW-GW 1 are in network domain 1, CB entity 3 and Data-TW-GW 2 are in network domain 2. Network domain 1 and Network domain 2 may be the same or not. The network domain includes but is not limited to a RAN, a CN, a DN and a terminal device. For example, network domain 1 is the RAN and network domain 2 is the CN, and vice versa. Network domain 1 is the RAN and network domain 2 is the DN, and vice versa. Network domain 1 is the CN and network domain 2 is the DN, and vice versa. Network domain 1 is the RAN and network domain 2 is the device, and vice versa.

In some cases, one or more of the network entities are in the DN. For example, CB entity 1, CB entity 2, Data-TW-GW 1 and Data-TW-GW 2 are in the CN, and CB entity 3 is in the DN. As another example, CB entity 1, CB entity 2 and Data-TW-GW 1 are in the RAN, Data-TW-GW 2 is in the CN, and CB entity 3 is in the DN. As another example, Data-TW-GW 2 and CB entity 3 are in the RAN, Data-TW-GW 1 is in the CN, and CB entity 1 and CB entity 2 are in the DN. As another example, Data-TW-GW 2, CB entity 3 and Data-TW-GW 1 are in the CN, and CB entity 1 and CB entity 2 are in the DN.

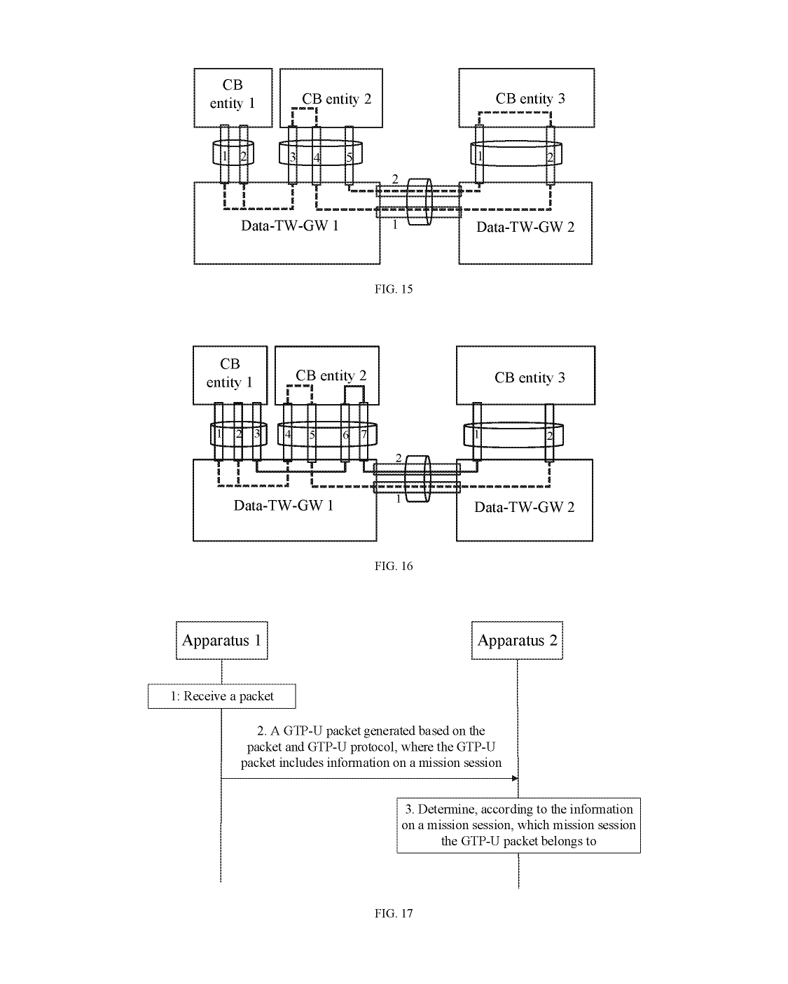

FIG. 15 is a schematic illustration of tunnels configured per mission session according to one or more embodiments of the present disclosure, as shown in FIG. 15, a rectangular represents a data session or an inter-GW session of a mission session, and a difference compared with FIG. 14 is that a cylindrical represents a tunnel configured for the mission session between two network entities. The tunnel is configured per mission session and may be shared by different data sessions or inter-GW sessions between the two network entities. The type of the tunnel is not limited to a GTP-U tunnel, a QUIC connection, etc. Tunnel 1 between CB entity 1 and Data-TW-GW 1 for the mission session is established, tunnel 2 between CB entity 2 and Data-TW-GW 1 for the mission session is established, tunnel 3 between CB entity 3 and Data-TW-GW 2 for the mission session is established, and tunnel 4 between Data-TW-GW 1 and Data-TW-GW 2 for the mission session is established. For example, some packets (e.g., packets of data session 3) received from tunnel 2 should be forwarded by Data-TW-GW 1 to CB entity 1, but some packets (e.g., packets of data session 4) received from tunnel 2 should be forwarded by Data-TW-GW 1 to Data-TW-GW 2 then to CB entity 3. Different from the case where a dedicated tunnel is configured per data session, when the tunnel is configured per mission session, additional information should be configured to enable a CB entity and/or a Data-TW-GW to detect, recognize and deliver a packet, and necessary information should be encapsulated into a packet header.

FIG. 16 is a schematic illustration of tunnels configured per network entity according to one or more embodiments of the present disclosure, as shown in FIG. 16, compared with FIG. 14 and FIG. 15, there are two mission sessions illustrated, which are respectively represented by a dash line and a solid line, a rectangular represents a data session or an inter-GW session of a mission session, and a cylindrical represents a tunnel shared by the two mission sessions between the network entities. Three data sessions 1, 2 and 3 are established between CB entity 1 and Data-TW-GW 1, four data sessions 4, 5, 6 and 7 are established between CB entity 2 and Data-TW-GW 1, and two data sessions 1 and 2 are established between CB entity 3 and Data-TW-GW 2. Data sessions 1 and 2 of CB entity 1, data sessions 4 and 5 of CB entity 2, and data session 2 of CB entity 3 belong to mission session 1. Data session 3 of CB entity 1, data sessions 6 and 7 of CB entity 2 and data session 1 of CB entity 3 belong to mission session 2. The tunnel is configured per network entity. It means the tunnel can be shared by different mission sessions of the network entity. The type of the tunnel is not limited to a GTP-U tunnel, a QUIC connection, etc. Tunnel 1 between CB entity 1 and Data-TW-GW 1 for the two mission sessions is established, tunnel 2 between CB entity 2 and Data-TW-GW 1 for the two mission sessions is established, tunnel 3 between CB entity 3 and Data-TW-GW 2 for the two mission sessions is established, and tunnel 4 between Data-TW-GW 1 and Data-TW-GW 2 for the two mission sessions is established. For example, some packets (e.g., packets of data session 4) received from tunnel 2 should be forwarded by Data-TW-GW 1 to CB entity 1, but some packets (e.g., packets of data session 5) received from tunnel 2 should be forwarded by Data-TW-GW 1 to Data-TW-GW 2 then to CB entity 3. Different from the cases where a tunnel is configured per data session (per inter-GW session) or per mission session, when the tunnel is configured per network entity, additional information should be configured to enable a CB entity and a Data-TW-GW to detect, recognize and deliver a packet, and necessary information should be encapsulated into a packet header.

As shown in FIGS. 14, 15, and 16, GTP-U tunnels may be configured with different granularities, e.g., per data session (per inter-GW session), per mission session, or per network entity (i.e., a tunnel is shared by multiple mission sessions). There are the following problems to be solved:

The mission service is provided via a mission session and a data session. It is different from 5G where the connectivity service is provided via a PDU session. In 5G, a GTP-U tunnel is configured per PDU session, and a network entity can associate a packet received from a GTP-U tunnel with a PDU session because the GTP-U tunnel is configured dedicatedly for the PDU session. For the mission service, how to enable a network entity to detect and distinguish which data session/inter-GW session a packet received from a GTP-U tunnel belongs to?

The data (inter-GW) session could be further refined into one or more QoS flows. For a connectivity service, the GTP-U header includes a QFI (e.g., in a PDU session container) to enable a network entity to detect and distinguish which data QoS flow a packet received from a GTP-U tunnel belongs to. For the mission service, how can a network entity detect and distinguish which QoS flow a packet received from a GTP-U tunnel belongs to?

In the present disclosure, new types of extension header (e.g., with new type value) are defined when GTP-U tunnels may be configured with different granularities, e.g., per data session (or per inter-GW session), per mission session, or per network entity: a data session container, an inter-GW session container, a mission session container, a CB entity container, a Data-TW-GW container, and ew fields are added into a GTP-U extension header:

o Add one or more of: a mission session ID, a data session ID (and/or assistance information), an inter-GW session ID (and/or assistance information), into the newly defined GTP-U extension header, when the GTP-U tunnel is configured per data session (or per inter-GW session), per mission session or per network entity.

The PDU session container is reused for the mission session but with new meaning of PDU session container including new fields.

FIG. 17 is a schematic flowchart of a communication method according to one or more embodiments of the present disclosure.

Referring to FIG. 17, a communication method is provided, including:

step 1: receiving a packet; and

step 2: transmitting a general packet radio service (GPRS) tunneling protocol for user plane (GTP-U) packet generated based on the packet and GTP-U protocol, where the GTP-U packet includes information on a mission session, the mission session is to provide a mission service to a mission customer, and the mission service is a service for both protocol data unit (PDU) connectivity and data processing.

Among them, the above method is implemented by a first apparatus (apparatus 1 shown in FIG. 17) participating a mission session, which may be implemented as a device, or one or more component included in a device, such as, a processor or a chip. The device may be user equipment, a terminal, a network device, a network function, a network node, or another network element, which is not limited in the present disclosure.

In some cases, the method further includes a step of determining the information on a mission session.

Correspondingly, an embodiment of the present disclosure further provides a communication method, including:

step 2: receiving a general packet radio service (GPRS) tunneling protocol for user plane (GTP-U) packet, where the GTP-U packet is a packet based on GTP-U protocol, the GTP-U packet includes information on a mission session, the mission session is to provide a mission service to a mission customer, and the mission service is a service for both protocol data unit (PDU) connectivity and data processing; and

step 3: determining, according to the information on a mission session, which mission session the GTP-U packet belongs to.

Among them, the above method is implemented by a second apparatus (apparatus 2 shown in FIG. 17) participating a mission session, which may be implemented as a device, or one or more component included in a device, such as, a processor or a chip. The device may be user equipment, a terminal, a network device, a network function, a network node, or another network element, which is not limited in the present disclosure.

In an implementation, the information on a mission session is included in a packet header of the GTP-U packet or a payload of the GTP-U packet.

It should be noted that, since the network entity include the CB entity and the Data-TW-GW (also named as the GW entity), in the present disclosure, for a CB entity, the term “per network entity” is equivalent to the term “per CB entity”; for a Data-TW-GW, the term “per network entity” is equivalent to the terms “per Data-TW-GW” and “per GW entity”.

### Tunnel granularity per data session and/or per inter-GW session

The GTP-U packet is transmitted through a GTP-U tunnel, and the GTP-U tunnel is dedicated for a data session. In other words, the granularity of the GTP-U tunnel can be the data session or the inter-GW session.

In some case, the information on a mission session includes a quality of service (QoS) flow identifier (QFI) and/or a CBID, where the QFI indicates a QoS flow associated with the GTP-U packet, the QoS flow is one of one or more QoS flows included in the data session, the CBID indicates a first CB associated with the GTP-U packet, and the data session corresponds to the one or more CBs including the first CB.

The information on a mission session is included in a packet header of the GTP-U packet, the packet header includes a GTP-U extension header, and the QFI and/or the CBID is included in the GTP-U extension header.

In an implementation, the GTP-U extension header may be a first type of GTP-U extension header, the first type of GTP-U extension header is a data session container. The information on a mission session includes a first field, the first type of GTP-U extension header is indicated by the first field, where a value of the first field is 1000 1000. The first field indicates that the GTP-U tunnel is dedicated for the data session through indicating the first type of GTP-U extension header.

In another implementation, the GTP-U extension header may be a second type of GTP-U extension header, and an indication is included in the GTP-U packet to indicate whether the second type of GTP-U extension header is for a data session. Among them, the indication is included in the second type of GTP-U extension header, or, the information on a mission session includes a second field, the indication is included in the second field. The indication is 2 bits, and a value of the 2 bits indicates that the second type of GTP-U extension header is for a PDU session or a data session. Alternatively, the information on a mission session includes a second field, and the indication is indicated by a range of values of the second field.

The GTP-U packet is transmitted through a GTP-U tunnel, and the GTP-U tunnel is dedicated for an inter-GW session.

In some cases, the information on a mission session includes a QFI and/or a CBID, where the QFI indicates a QoS flow associated with the GTP-U packet, the QoS flow is one of one or more QoS flows included in the inter-GW session, the CBID indicates a first CB associated with the GTP-U packet, and one data session or one inter-GW session corresponds to the one or more CBs including the first CB.

Furthermore, the information on a mission session is included in a packet header of the GTP-U packet, the packet header includes a GTP-U extension header, and the QFI and/or the CBID is included in the GTP-U extension header.

In an implementation, the GTP-U extension header may be a first type of GTP-U extension header, the first type of GTP-U header is an inter-GW session container. The information on a mission session includes a first field, the first type of GTP-U extension header is indicated by the first field, where a value of the first field is 1000 1001. The first field indicates that the GTP-U tunnel is dedicated for the inter-GW session through indicating the first type of GTP-U extension header.

In another implementation, the GTP-U extension header is a second type of GTP-U extension header, and an indication is included in the GTP-U packet to indicate whether the second type of GTP-U extension header is for an inter-GW session. Among them, the indication is included in the second type of GTP-U extension header, or, the information on a mission session includes a second field, the indication is included in the second field. The indication is 2 bits, and a value of the 2 bits indicates that the second type of GTP-U extension header is for a PDU session or an inter-GW session. Alternatively, the information on a mission session includes a second field, and the indication is indicated by a range of values of the second field.

In order to enable a receiving network entity to distinguish a specific data session or an inter-GW session related to a received packet, there are two main concept: defining a new type of GTP-U extension header for including the information on a mission session, and reusing an existing GTP-U extension header for including the information on a mission session.

Specifically, in the case of defining a new type of GTP-U extension header, as shown in FIG. 14, a GTP-U tunnel is configured per data session or per inter-GW session for a mission session. New types of GTP-U extension headers may be defined.

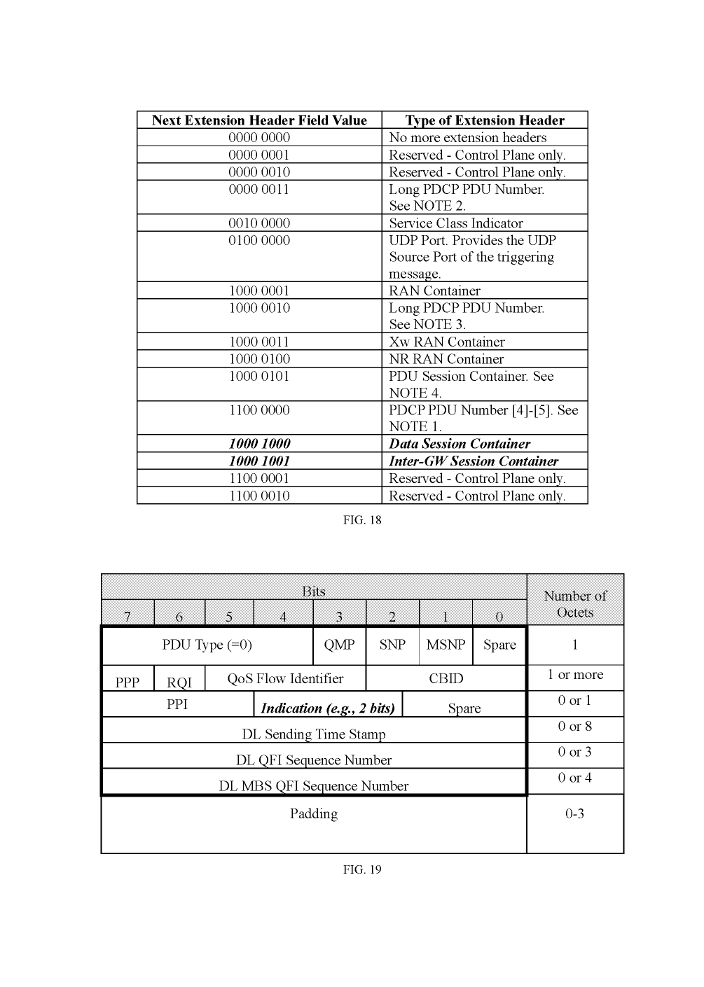

FIG. 18 is a schematic illustration of definitions of extension header types according to one or more embodiments of the present disclosure. As shown in FIG. 18, a type of “data session container” is defined, and a corresponding “next extension header field value” is defined. And a type of “inter-GW session container” is defined, and a corresponding “next extension header field value” is defined. The first field included in the information on a mission session may be referred to as the next extension header field cited above. For the data session container, the value of the first field (i.e., the next extension header field) may be 1000 1000, and for the inter-GW session container, the value of the first field (i.e., the next extension header field) may be 1000 1001.

The characteristic and use of the new type of GTP-U extension header may follow the methods of the general GTP-U extension header described in FIGS. 7, 8 and 9.

It should be noted that, the format of the GTP-U extension headers may be referred to as the format described in FIG. 9.

The type of a data session container may be indicated with a specific field value (e.g., a next extension header field value), e.g., 1000 1000 or another reserved value.

There is a data session container encapsulated in a GTP-U packet when the type of the extension header is set to a data session container (e.g., with a next extension header field value being set to 10001000). Such data session container extension header may be transmitted over a network interface, between network entities, e.g., between CB entities, between a CB entity and a Data-TW-GW. The CB entity may be in a device, a RAN, a CN and a DN. The Data-TW-GW may be in a device, a RAN, a CN and a DN. In some cases, the Data-TW-GW may be a UPF or an evolved UPF. The data session container may have a variable length. And the data session container includes information (control information elements, data processing and/or data forwarding instruction information) to be associated with a data session.

In some cases, a data session includes one or more QoS flows. The one or more QoS flows are transmitted via the data session. The QoS flow is the finest granularity of QoS differentiation in the data session. Traffic within a QoS flow of a data session receives the same data forwarding treatment (e.g. scheduling, an admission threshold, delay, and a loss rate) and/or data processing treatment (e.g., data processing delay, data processing accuracy, data processing privacy). A QoS flow ID (QFI) is used to identify a QoS flow.

A content of a data session container includes the QFI and/or a CBID. That is, the information on a mission session may include the QFI and/or a CBID. A network entity (e.g., a CB entity, a Data-TW-GW) may use a received QFI to determine a QoS flow and a QoS profile which are associated with the received packet of the data session, and use a received CBID to determine a CB associated with the GTP-U packet.

In some cases, a content of a data session container for a downlink packet (e.g., an ingress packet) and an uplink packet (e.g., an egress packet) may be as shown in FIGS. 10 and 11, respectively.

In some cases, data session data plane protocol data is conveyed by GTP-U protocol means, more specifically, by means of the "data session container" in a GTP-U extension header.

When a network entity receives a packet including a data session container (and optional a QFI, e.g., the QFI is included if the data session includes one or more QoS flows) from a tunnel, the network entity can determine (optional a QFI of) a data session of a mission session which the packet belongs to. The data session can be determined because the tunnel is configured dedicatedly for the data session. The mission session can be determined because the data session belongs to the mission (e.g., a relation between a mission session and a data session is preconfigured to the network entity when the mission session is established). The QoS flow can be determined based on the QFI.

The type of an inter-GW session container can be indicated with a specific field value (e.g., a next extension header field value), e.g., 1000 1001 or another reserved value.

There is an inter-GW session container encapsulated in a GTP-U packet when the type of extension header is set to an inter-GW session Container (e.g., with a next extension header field value being set to 10001001). Such inter-GW session container extension header may be transmitted over a network interface, between network entities, e.g., between CB entities, between a CB entity and a Data-TW-GW, between Data-TW-GWs. The CB entity can be in a device, a RAN, a CN and a DN. The Data-TW-GW may be in a device, a RAN, a CN and a DN. In some cases, the Data-TW-GW may be a UPF or an evolved UPF. The inter-GW session container may have a variable length. And the inter-GW session container includes information (control information elements and/or data forwarding instruction information) to be associated with an inter-GW session.

In some cases, an inter-GW session includes one or more QoS flows. The one or more QoS flows are transmitted via the inter-GW session. The QoS Flow is the finest granularity of QoS differentiation in the inter-GW session. Traffic within a QoS flow of an inter-GW session receives the same data forwarding treatment (e.g. scheduling, an admission threshold, delay, and a loss rate) and/or data processing treatment (e.g., data processing delay, data processing accuracy, data processing privacy). A QoS flow ID (QFI) is used to identify a QoS flow.

A content of an inter-GW session container includes the QFI and/or a CBID. That is, the information on a mission session may include the QFI and/or a CBID. A network entity (e.g., a CB entity, a Data-TW-GW) may use a received QFI to determine a QoS flow and a QoS profile which are associated with the received packet of the inter-GW session, and use a received CBID to determine a CB associated with the GTP-U packet.

In some cases, a content of an inter-GW session container for a downlink packet (e.g., an ingress packet) and an uplink packet (e.g., an egress packet) may be as shown in FIGS. 10 and 11, respectively.

In some cases, inter-GW session data plane protocol data is conveyed by GTP-U protocol means, more specifically, by means of the "inter-GW session container" in a GTP-U extension header.

When a network entity receives a packet including an inter-GW session container (and optional a QFI, e.g., the QFI is included if the inter-GW session includes one or more QoS flows) from a tunnel, the network entity can determine (optional a QFI of) an inter-GW session of a mission session which the packet belongs to. The inter-GW session can be determined because the tunnel is configured dedicatedly for the inter-GW session. The mission session can be determined because the inter-GW session belongs to the mission (e.g., a relation between a mission session and an inter-GW session is preconfigured to the network entity when the mission session is established). The QoS flow can be determined based on the QFI.

Specifically, in the case of reusing an existing GTP-U extension header, a GTP-U tunnel is configured per data session or per inter-GW session for a mission session. A PDU session container (or another container, e.g., a RAN container, and etc.) is reused instead of defining a new type of GTP-U extension header. In some cases, the information conveyed in the PDU session container may be as shown in FIGS. 10 or 11. And the second type of GTP-U extension header may be referred to as the PDU session container, the RAN container, a (new radio) NR RAN container, or an Xw RAN container, and the like. It should be noted that the PDU session container is taken as an example for explaining.

In the related art, the PDU session container may be transmitted over the N3 and N9 user plane interfaces, between a NG-RAN and a UPF, or between two UPFs; over the N3mb and N19mb user plane interfaces, between an MB-UPF and a NG-RAN, or between a MB-UPF and a UPF; and over data forwarding tunnels in 5GS, for data forwarding between a 5GS and an EPS. The PDU session container has a variable length and its content is specified in 3GPP TS 38.415. The RAN Container may be transmitted over the X2 user plane interfaces between eNBs. The RAN container has a variable length and its content is specified in 3GPP TS 36.425. The NR RAN container may be transmitted in a G-PDU over the X2-U, Xn-U and F1-U user plane interfaces. The NR RAN container has a variable length and its content is specified in 3GPP TS 38.425. The Xw user plane interface is between an eNB and a WLAN Termination (WT). The Xw RAN Container has a variable length and its content is specified in 3GPP TS 36.465.

The characteristic and use of the PDU session container may follow the methods of the general GTP-U extension header described in FIGS. 7, 8 and 9.

It should be noted that, the format of the GTP-U extension headers may be referred to as the format described in FIG. 9.

In some cases, the PDU session container includes an indication to distinguish that the PDU session container is for a PDU session, a data session, or an inter-GW session. For example, the indication may be 2 bits. When the 2 bits are set to 00, it indicates that the PDU session container is for a PDU session, when the 2 bits are set to 01, it indicates that the PDU session container is for a data session, and when the 2 bits are set to 10, it indicates that the PDU session container is for an inter-GW session.

In some cases, the indication may also be located outside from the PDU session container. For example, a field value (e.g., a next extension header field value) for the PDU session container is extended to distinguish that the PDU session container is for a PDU session, a data session, or an inter-GW session. For example, 1000 0101 indicates that the packet is associated with a PDU session, 10001000 indicates that the packet is associated with a data session, and 10001001 indicates that the packet is associated with an inter-GW session. As another example, the indication (e.g., the 2 bits) may be in a field of a TEID. As another example, a first range of TEIDs may be reserved for a PDU session, a second range of TEIDs may be reserved for a data session, and a third range of TEIDs may be reserved for an inter-GW session. The second field included in the information on a mission session may be referred to as the TEID cited above.

FIG. 19 is a schematic illustration of an evolved format of downlink (DL) PDU session information according to one or more embodiments of the present disclosure. In some cases, a format of information (e.g., PDU session information) included in a PDU session container for a downlink packet (e.g., an ingress packet) is shown as in FIG. 19 (which is an evolved figure of FIG. 10). Referring to FIG. 19, a spare field includes the indication (e.g., 2 bits).

Similarly, a spare field of PDU session information included in a PDU session container for an uplink packet includes the indication (e.g., 2 bits), and a corresponding evolved figure of FIG. 11 is omitted here.

It should be noted that the location of the indication in the PDU session container is not limited, e.g., within, before, or after other fields. For example, the indication (e.g., the 2 bits) may be in, before, or after the field of padding.

When a network entity receives a packet including an indication (and optional a QFI, e.g., the QFI is included if a data session (inter-GW) session includes one or more QoS flows) from a tunnel, the network entity can determine a PDU session, or (optional a QFI of) a data (inter-GW) session of a mission session which the packet belongs to. The mission session can be determined because the tunnel is configured dedicatedly for a PDU session and/or the data (or inter-GW) session. The mission session can be determined because the data (inter-GW) session belongs to the mission (e.g., a relation between a mission session and a data (inter-GW) session is preconfigured to the network entity when the mission session is established). The QoS flow can be determined based on the QFI.

In some cases, if data (inter-GW) session instead of the QoS flow is the finest granularity of traffic, QFI is not included in the GTP-U header; otherwise, QFI is included in the GTP-U header.

In some cases, a range values of TEIDs may be reserved for a data session.

In some cases, a range values of TEIDs may be reserved for an inter-GW session.

In some cases, a range values of TEIDs may be reserved for a mission session.

In some cases, a type of “data session container” or “inter-GW session container” is not defined. For example, a range values of TEIDs may be reserved for a data session or an inter-GW session, based on which the network entity can know that the GTP-U packet belongs to a data session or an inter-GW session instead of others (e.g., a PDU session).

### Tunnel granularity per mission session

The GTP-U packet is transmitted through a GTP-U tunnel, and the GTP-U tunnel is dedicated for the mission session and is shared by one or more data sessions and/or one or more inter-GW sessions of the mission session. In other words, the granularity of the GTP-U tunnel can be the mission session.

In some cases, the information on a mission session includes either or both of a data session ID and assistance information, the data session ID is used to identify a data session included in the one or more data sessions, and the assistance information is used for assisting in distinguishing the data session or distinguishing a CB.

Furthermore, the information on a mission session further includes a QFI and/or a CBID, where the QFI indicates a QoS flow associated with the GTP-U packet, the QoS flow is one of one or more QoS flows included in the data session; the CBID indicates a first CB associated with the GTP-U packet, and the data session corresponds to the one or more CBs including the first CB.

In some cases, the information on a mission session includes either or both of an inter-GW session ID and assistance information, the inter-GW session ID is used to identify an inter-GW session, and the assistance information is used for assisting in distinguishing the inter-GW session or distinguishing a CB.

Furthermore, the information on a mission session further includes a QFI and/or a CBID, where the QFI indicates a QoS flow associated with the GTP-U packet, the QoS flow is one of one or more QoS flows included in the inter-GW session; the CBID indicates a first CB associated with the GTP-U packet, and one data session or one inter-GW session corresponds to the one or more CBs including the first CB.

In some cases, the information on a mission session includes a QFI and/or a CBID, where the QFI indicates a QoS flow associated with the GTP-U packet, the QoS flow is one of one or more QoS flows of the mission session; the CBID indicates a first CB associated with the GTP-U packet, and one data session or one inter-GW session corresponds to the one or more CBs including the first CB.

The information on a mission session is included in a packet header of the GTP-U packet, the packet header includes a GTP-U extension header, and one or more of: the data session ID, the inter-GW session ID, the assistance information, the QFI or the CBID, is included in the GTP-U extension header.

In an implementation, the GTP-U extension header is a first type of GTP-U extension header, and the first type of GTP-U extension header is a mission session container. The information on a mission session includes a first field, the first type of GTP-U extension header is indicated by the first field, where a value of the first field is 1000 1010. The first field indicates that the GTP-U tunnel is dedicated for the mission session through indicating the first type of GTP-U extension header.

In another implementation, the GTP-U extension header is a second type of GTP-U extension header, and an indication is included in the GTP-U packet to indicate whether the second type of GTP-U extension header is for a mission session. Among them, the indication is included in the second type of GTP-U extension header, or, the information on a mission session includes a second field, the indication is included in the second field. The indication is 2 bits, and a value of the 2 bits indicates that the second type of GTP-U extension header is for a PDU session or a mission session. Alternatively, the information on a mission session includes a second field, and the indication is indicated by a range of values of the second field.

Specifically, in the case of defining a new type of GTP-U extension header, as shown in FIG. 15, the GTP-U tunnel is configured per mission session. A new type of a GTP-U extension header may be defined.

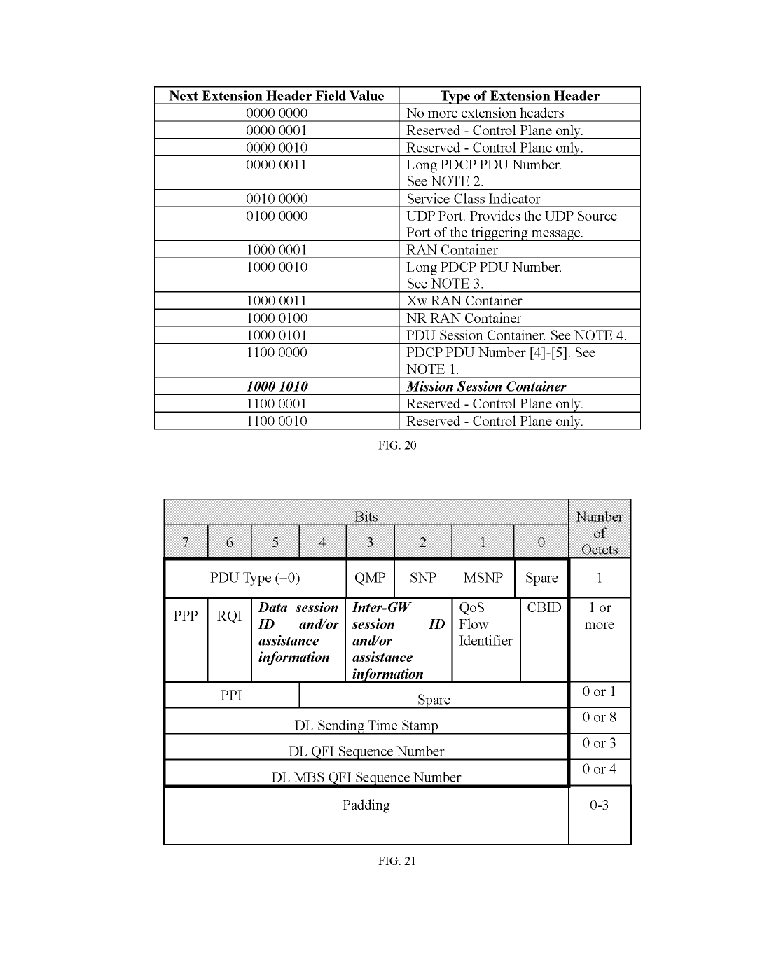

FIG. 20 is a schematic illustration of definitions of extension header types according to one or more embodiments of the present disclosure. As shown in FIG. 20, a type of “mission session container” is defined, and a corresponding “next extension header field value” is defined. The first field included in the information on a mission session may be referred to as the next extension header field cited above. For the mission session container, the value of the first field (i.e., the next extension header field) may be 1000 1010.

The characteristic and use of the new type of GTP-U extension header may follow the methods of the general GTP-U extension header described in FIGS. 7, 8 and 9.

It should be noted that, the format of the GTP-U extension header can be referred to as the format described in FIG. 9.

The type of a mission session container may be indicated with a specific field value (e.g., a next extension header field value), e.g., 1000 1010 or another reserved value.

There is a mission session container encapsulated in a GTP-U packet when the type of extension header is set to a mission session container (e.g., with a next extension header field value being set to 10001010). Such mission session container extension header may be transmitted over a network interface, between network entities, e.g., between CB entities, between a CB entity and a Data-TW-GW. The CB entity may be in a device, a RAN, a CN and a DN. The Data-TW-GW may be in a device, a RAN, a CN and a DN. In some cases, the Data-TW-GW may be a UPF or an evolved UPF. The mission session container may have a variable length. And the mission session container includes information (control information elements, data processing and/or data forwarding instruction information) to be associated with a data session and/or an inter-GW session of a mission session.

A data session ID and/or assistance information may be included in the mission session container. Based on the data session ID and/or the assistance information, the network entity (e.g., a CB entity, a Data-TW-GW) can detect and distinguish which data session a packet received from the tunnel of a mission session belongs to.

The assistance information is used to assist in distinguishing which data session a packet received from/delivered to a tunnel of a mission session belongs to.

When a data session ID alone is enough to be used to distinguish which data session a packet received from/delivered to a tunnel of a mission session belongs to, and the data session ID is encapsulated into the packet (e.g., a packet header, or a packet payload), assistance information needs not to be included in the packet. For example, when a value of a data session ID is assigned globally unique within a mission session, or is assigned globally unique among different data session IDs of all data sessions of the mission session, the data session ID alone is enough to be used to distinguish packets.

When a data session ID alone is not enough to distinguish which data session a packet received from/delivered to a tunnel of a mission session belongs to, or the data session ID is not encapsulated into the packet (e.g., a packet header, or a packet payload), assistance information needs to be configured.

In some cases, the assistance information may be one or more of: an action ID identifying an action of data processing, a CBID identifying a CB, a step ID identifying a step of a procedure, and a mission customer ID identifying a customer of a mission session. The data processing may be but not limited to AI training, AI inference, data pre-processing, data de-privatization (data privacy protection), data cleaning, data collection, data analytics, sensing, data sanitization, data management, data normalization, useless data filtering, data feature engineering, data compression, data embedding, data representation learning, and data feature extraction.

In some cases, the data session ID and/or the assistance information to be detected or encapsulated in packet are configured by a C/M plane function (e.g., a mission control function (MCF)) to the network entity. In some cases, before the configuration, the data session ID and/or the assistance information (e.g., to be detected from a packet by a network entity) are reported to a C/M plane function by a peer node (e.g., a Data-TW-GW) of the network entity.

In some cases, if assistance information (e.g., an action ID, a CBID) alone is enough to be used to distinguish which data session a packet received from/delivered to a tunnel of a mission session belongs to, and the assistance information (e.g., an action ID) is encapsulated into the packet (e.g., a packet header, or a packet payload), a data session ID needs not to be encapsulated into the packet header.

In some cases, if assistance information (e.g., an action ID, a CBID) alone is not enough to be used to distinguish which data session a packet received from/delivered to a tunnel of a mission session belongs to, both of a data session ID and the assistance information (e.g., an action ID) need to be encapsulated into the packet (e.g., a packet header, or a packet payload).

Similarly, an inter-GW session ID and/or assistance information may be included in the mission session container. Based on the inter-GW session ID and/or the assistance information, the network entity (e.g., a CB entity, a Data-TW-GW) can detect and distinguish which inter-GW session a packet received from the tunnel of a mission session belongs to.

The assistance information is used to assist in distinguishing which inter-GW session a packet received from/delivered to a tunnel of a mission session belongs to.

When an inter-GW session ID alone is enough to be used to distinguish which inter-GW session a packet received from/delivered to a tunnel of a mission session belongs to, and the inter-GW session ID is encapsulated into a packet (e.g., a packet header, or a packet payload), assistance information needs not to be included in the packet. For example, when a value of an inter-GW session ID is assigned globally unique within a mission session, or is assigned globally unique among different inter-GW session IDs of all inter-GW sessions of the mission session, the inter-GW session ID alone is enough to be used to distinguish packets.

When an inter-GW session ID alone is not enough to distinguish which inter-GW session a packet received from/delivered to a tunnel of a mission session belongs to, or the inter-GW session ID is not encapsulated into the packet (e.g., a packet header, or a packet payload), assistance information needs to be configured.

In some cases, the assistance information may be one or more of: an action ID identifying an action of data processing, a CBID identifying a CB, a step ID identifying a step of a procedure, and a mission customer ID identifying a customer of a mission session. The data processing may be but not limited to AI training, AI inference, data pre-processing, data de-privatization (data privacy protection), data cleaning, data collection, data analytics, sensing, data sanitization, data management, data normalization, useless data filtering, data feature engineering, data compression, data embedding, data representation learning, and data feature extraction.

In some cases, the inter-GW session ID and/or the assistance information to be detected or encapsulated in packet are configured by a C/M plane function (e.g., an MCF) to the network entity. In some cases, before the configuration, the inter-GW session ID and/or the assistance information (e.g., to be detected from a packet by a network entity) are reported to a C/M plane function by a peer node (e.g., Data-TW-GW) of the network entity.

In some cases, if assistance information (e.g., an action ID, a CBID) alone is enough to be used to distinguish which inter-GW session a packet received from/delivered to a tunnel of a mission session belongs to, and the assistance information (e.g., an action ID) is encapsulated into the packet (e.g., a packet header, or a packet payload), an inter-GW session ID needs not to be encapsulated into the packet header.

In some cases, if assistance information (e.g., an action ID, a CBID) alone is not enough to be used to distinguish which inter-GW session a packet received from/delivered to a tunnel of a mission session belongs to, both of an inter-GW session ID and the assistance information (e.g., an action ID) need to be encapsulated into the packet (e.g., a packet header, or a packet payload).

In some cases, the mission session data plane protocol data is conveyed by GTP-U protocol means, more specifically, by means of the "mission session container" in a GTP-U extension header.

In some cases, a data (inter-GW) session includes one or more QoS flows. The one or more QoS flows are transmitted via the data (inter-GW) session. A content of the mission session container includes a QFI and/or a CBID. That is, the information on a mission session may include the QFI and/or a CBID. A network entity (e.g., a CB entity, a Data-TW-GW) may use a received QFI to determine a QoS flow and a QoS profile which are associated with the received packet of the data (inter-GW) session of the mission session, and use a received CBID to determine a CB associated with the GTP-U packet.

FIG. 21 is a schematic illustration of a format of DL mission session information according to one or more embodiments of the present disclosure. In some cases, a format of information (e.g., mission session information) included in a mission session container for a downlink packet (e.g., an ingress packet) is shown as in FIG. 21 (which is an evolved figure of FIG. 10).

Referring to FIG. 21, the mission session container for a downlink packet includes new fields of: a data session ID and/or assistance information (e.g., an action ID) for the data session ID, an inter-GW session ID and/or assistance information (e.g., an action ID) for the inter-GW session ID. The information on a mission session may include the information carried in the new fields.

Similarly, information (e.g., mission session information) included in a mission session container for an uplink packet includes new fields of: a data session ID and/or assistance information (e.g., an action ID) for the data session ID, an inter-GW session ID and/or assistance information (e.g., an action ID) for the inter-GW session ID, and a corresponding evolved figure of FIG. 11 of the format is omitted here.

It should be noted that the location of the new fields in the mission session container is not limited, e.g., within, before, or after other fields. For example, the new fields can be in, before, or after the field of padding.

When a network entity receives a packet including a mission session container from a tunnel of a mission session, the network entity can determine (optional a QFI of) a data (inter-GW) session of the mission session which the packet belongs to. The mission session can be determined because the tunnel is configured dedicatedly for the mission session. The data session can be determined based on the data session ID and/or assistance information (e.g., an action ID) encapsulated in the packet (e.g., a packet header). The inter-GW session can be determined based on the inter-GW session ID and/or assistance information (e.g., an action ID) encapsulated in the packet (e.g., a packet header). The QoS flow can be determined based on the QFI.

In some cases, if data (inter-GW) session instead of the QoS flow is the finest granularity of traffic, QFI is not included in the GTP-U header, e.g., the data (inter-GW) session ID and/or assistance information replace the fields of QFI in FIGS. 10 and 11; otherwise, QFI together with the new fields are included in the GTP-U header.

Specifically, in the case of reusing an existing GTP-U extension header, a GTP-U tunnel is configured per mission session for a mission session. A PDU session container (or another container, e.g., a RAN container, and etc.) is reused instead of defining a new type of GTP-U extension header. In some cases, the information conveyed in the PDU session container may be as shown in FIGS. 10 or 11. And the second type of GTP-U extension header may be referred to as the PDU session container, the RAN container, a (new radio) NR RAN container, or an Xw RAN container, and the like. It should be noted that the PDU session container is taken as an example for explaining.

The characteristic and use of the PDU session container may follow the methods of the general GTP-U extension header described in FIGS. 7, 8 and 9.

It should be noted that, the format of the GTP-U extension headers may be referred to as the format described in FIG. 9.

When either or both of a data session ID (and/or assistance information) and an inter-GW session ID (and/or assistance information) are included in a PDU session container, it implicitly indicates that the PDU session container is for a mission session; otherwise, it is for a PDU session.

In some cases, the PDU session container includes an indication to distinguish that the PDU session container is for a PDU session or a mission session. For example, the indication may be 2 bits.

In some cases, the indication may also be located outside from the PDU session container. For example, a field value (e.g., a next extension header field value) for the PDU session container is extended to distinguish that the PDU session container is for a PDU session, or a mission session. For example, 1000 0101 indicates that the packet is associated with a PDU session, 10001010 indicates that the packet is associated with a mission session. As another example, the indication (e.g., the 2 bits) may be in a field of a TEID. As another example, a first range of TEIDs may be reserved for a PDU session, a second range of TEIDs may be reserved for a mission session. The second field included in the information on a mission session may be referred to as the TEID cited above.

In some cases, a format of information (e.g., PDU session information) included in a PDU session container for a downlink packet (e.g., an ingress packet) may be as shown in FIG. 21. That is, the above information on a mission session may also be included in the PDU session container.

Similarly, PDU session information included in a PDU session container for an uplink packet also includes the new fields, and a corresponding evolved figure of FIG. 11 is omitted here.

It should be noted that the location of the new fields in the PDU session container is not limited, e.g., within, before, or after other fields. For example, the new fields can be in, before, or after the field of padding.

When a network entity receives a packet including the new fields (and optional a QFI, e.g., the QFI is included if the data (inter-GW) session includes one or more QoS flows) from a tunnel, the network entity can determine a mission session, or (optional a QFI of) a data (inter-GW) session of the mission session which the packet belongs to. The mission session can be determined because the tunnel is configured dedicatedly for a PDU session and/or the mission session. The data session can be determined based on the data session ID and/or assistance information (e.g., an action ID) encapsulated in the packet (e.g., a packet header). The inter-GW session can be determined based on the inter-GW session ID and/or assistance information (e.g., an action ID) encapsulated in the packet (e.g., a packet header). The QoS flow can be determined based on the QFI.

The description above does not limit a location of the new field in the GTP-U packet. In some cases, the new field (e.g., a data session ID, an inter-GW session ID, assistance information) are in other location of the GTP-U header, e.g., in a TEID.

In some cases, a range values of TEIDs may be reserved for a data session.

In some cases, a range values of TEIDs may be reserved for an inter-GW session.

In some cases, a range values of TEIDs may be reserved for a mission session.

In some cases, a type of “mission session container” is not defined. For example, a range values of TEIDs may be reserved for a mission session, based on which the network entity can know that the GTP-U packet belongs to a mission session instead of others (e.g., a PDU session).

### Tunnel granularity per network entity

The GTP-U packet is transmitted through a GTP-U tunnel, the GTP-U tunnel is dedicated for a CB entity and is shared by one or more mission sessions of the CB entity, and the one or more mission sessions include the mission session.

In some cases, the information on a mission session includes one or more of: a mission session ID, a data session ID or assistance information; the mission session ID is used to identify a first mission session, the data session ID is used to identify a data session included in the first mission session, and the assistance information is used for assisting in distinguishing the data session or distinguishing a CB.

Furthermore, the information on a mission session further includes a QFI and/or a CBID, where the QFI indicates a QoS flow associated with the GTP-U packet, the QoS flow is one of one or more QoS flows included in the data session; the CBID indicates a first CB associated with the GTP-U packet, and the data session corresponds to the one or more CBs including the first CB.

In some cases, the information on a mission session includes a QFI and/or a CBID, where the QFI indicates a QoS flow associated with the GTP-U packet, the QoS flow is one of one or more QoS flows of the one or more mission sessions of the CB entity, the CBID indicates a first CB associated with the GTP-U packet, and the data session corresponds to the one or more CBs including the first CB.

The information on a mission session is included in a packet header of the GTP-U packet, the packet header includes a GTP-U extension header, and one or more of: the mission session ID, the data session ID, the assistance information, the QFI or the CBID, is included in the GTP-U extension header.

In an implementation, the GTP-U extension header is a first type of GTP-U extension header, the first type of GTP-U extension header is a CB entity container. The information on a mission session includes a first field, and the first type of GTP-U extension header is indicated by the first field, where a value of the first field is 1000 1011. The first field indicates that the GTP-U tunnel is dedicated for the CB entity through indicating the first type of GTP-U extension header.

In another implementation, the GTP-U extension header is a second type of GTP-U extension header, and an indication is included in the GTP-U packet to indicate whether the second type of GTP-U extension header is for a CB entity. Among them, the indication is included in the second type of GTP-U extension header, or, the information on a mission session includes a second field, the indication is included in the second field. The indication is 2 bits, and a value of the 2 bits indicates that the second type of GTP-U extension header is for a PDU session or a CB entity. Alternatively, the information on a mission session includes a second field, and the indication is indicated by a range of values of the second field.

The GTP-U packet is transmitted through a GTP-U tunnel, the GTP-U tunnel is dedicated for a GW entity and is shared by one or more mission sessions of the GW entity, and the one or more mission sessions include the mission session.

In some cases, the information on a mission session includes one or more of: a mission session ID, a data session ID or first assistance information, or includes one or more of: a mission session ID, an inter-GW session ID or second assistance information; the mission session ID is used to identify a first mission session, the data session ID is used to identify a data session included in the first mission session, and the first assistance information is used for assisting in distinguishing the data session or distinguishing a CB; or the mission session ID is used to identify a first mission session, the inter-GW session ID is used to identify an inter-GW session included in the first mission session, and the second assistance information is used for assisting in distinguishing the inter-GW session or distinguishing a CB.

Furthermore, the information on a mission session further includes a QFI and/or a CBID, where the QFI indicates a QoS flow associated with the GTP-U packet, the QoS flow is one of one or more QoS flows included in the data session or in the inter-GW session; the CBID indicates a first CB associated with the GTP-U packet, and one data session or one inter-GW session corresponds to the one or more CBs including the first CB.

In some cases, the information on a mission session includes a QFI and/or a CBID, where the QFI indicates a QoS flow associated with the GTP-U packet, the QoS flow is one of one or more QoS flows of the one or more mission sessions of the GW entity, the CBID indicates a first CB associated with the GTP-U packet, and one data session or one inter-GW session corresponds to the one or more CBs including the first CB.

The information on a mission session is included in a packet header of the GTP-U packet, the packet header includes a GTP-U extension header, and one or more of: the mission session ID, the data session ID, the inter-GW session ID, the first assistance information, the second assistance information, the QFI or the CBID, is included in the GTP-U extension header.

In an implementation, the GTP-U extension header is a first type of GTP-U extension header, the first type of GTP-U extension header is a GW entity container. The information on a mission session includes a first field, the first type of GTP-U extension header is indicated by the first field, where a value of the first field is 1000 1100. The first field indicates that the GTP-U tunnel is dedicated for the GW entity through indicating the first type of GTP-U extension header.

In another implementation, the GTP-U extension header is a second type of GTP-U extension header, and an indication is included in the GTP-U packet to indicate whether the second type of GTP-U extension header is for a GW entity. Among them, the indication is included in the second type of GTP-U extension header, or, the information on a mission session includes a second field, the indication is included in the second field. The indication is 2 bits, and a value of the 2 bits indicates that the second type of GTP-U extension header is for a PDU session or a GW entity. Alternatively, the information on a mission session includes a second field, and the indication is indicated by a range of values of the second field.

Specifically, in the case of defining a new type of GTP-U extension header, as shown in FIG. 16, the GTP-U tunnel is configured per network entity. Among them, the GTP-U tunnel may be shared by multiple mission sessions. A new type of GTP-U extension header may be defined.

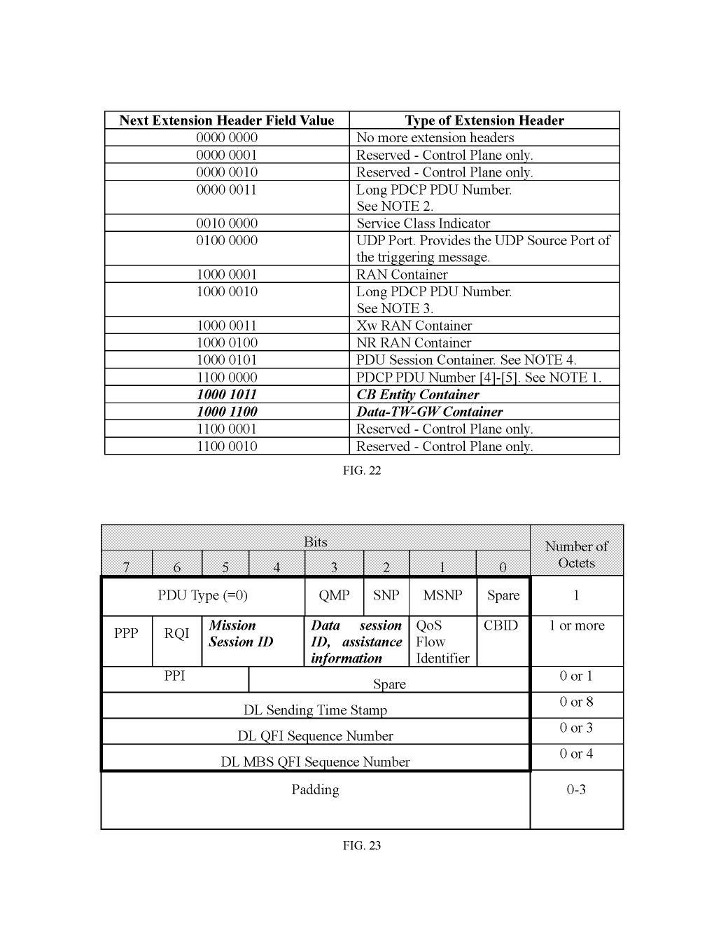

FIG. 22 is a schematic illustration of definitions of extension header types according to one or more embodiments of the present disclosure. As shown in FIG. 22, a type of “CB entity container” is defined, and a corresponding “next extension header field value” is defined.

And a type of “Data-TW-GW container” is defined, and a corresponding “next extension header field value” is defined. The GW entity container may be referred to as the Data-TW-GW container cited above. The first field included in the information on a mission session may be referred to as the next extension header field cited above. For the CB entity container, the value of the first field (i.e., the next extension header field) may be 1000 1011, and for the GW entity container, the value of the first field (i.e., the next extension header field) may be 1000 1100.

The characteristic and use of the new type of GTP-U extension header may follow the methods of the general GTP-U extension header of described in FIGS. 7, 8 and 9.

It should be noted that, the format of the GTP-U extension headers can be referred to as the format described in FIG. 9.

The type of a CB entity container may be indicated with a specific field value (e.g., a next extension header field value), e.g., 1000 1011 or another reserved value.

There is a CB entity container encapsulated in a GTP-U packet when the type of the extension header is set to a CB entity container (e.g., with a next extension header field value being set to 10001011). Such CB entity container extension header may be transmitted over a network interface, between network entities, e.g., between CB entities, between a CB entity and a Data-TW-GW. The CB entity may be in a device, a RAN, a CN and a DN. The Data-TW-GW may be in a device, a RAN, a CN and a DN. In some cases, the Data-TW-GW may be a UPF or an evolved UPF. The CB entity container may have a variable length. And the CB entity container includes information (control information elements, data processing and/or data forwarding instruction information) to be associated with a data session of a mission session.

One or more of: a mission session ID, a data session ID and assistance information are included in the CB entity container. Based on the one or more of the mission session ID, data session ID and assistance information, the network entity (e.g., a CB entity) can detect and distinguish which data session a packet received from the tunnel shared by multiple mission sessions belongs to.

The assistance information is used to assist in distinguishing which data session a packet received from/delivered to a tunnel shared by mission sessions belongs to.

In some cases, when a mission session ID and a data session ID together are enough to be used to distinguish which data session a packet received from/delivered to a tunnel shared by mission sessions belongs to, and the mission session ID and the data session ID together are encapsulated into the packet (e.g., a packet header, or a packet payload), assistance information needs not to be included in the packet. For example, when a value of a data session ID is assigned globally unique within a mission session, and the value of a mission session ID is assigned globally unique among different mission sessions, the mission session ID and the data session ID together are enough to be used to distinguish packets.

In some cases, when a data session ID alone is enough to be used to distinguish which data session a packet received from/delivered to a tunnel shared by mission sessions belongs to, and the data session ID is encapsulated into the packet (e.g., a packet header, or a packet payload), assistance information needs not to be included in the packet. For example, when a data session ID is assigned globally unique among different data session IDs of all data sessions for all mission sessions established between two network entities, the data session ID alone is enough to be used to distinguish packets.

In some cases, when a mission session ID and a data session ID together are not enough to distinguish which data session a packet received from/delivered to a tunnel shared by mission sessions belongs to, assistance information needs to be included in a packet header.

In some cases, when a mission session ID and a data session ID together are enough to distinguish which data session a packet received from/delivered to a tunnel shared by mission sessions belongs to, but either the mission session ID or the data session ID (e.g., only the mission session ID, or the data session ID is encapsulated in the packet) is not encapsulated into the packet (e.g., a packet header, or a packet payload), assistance information needs to be included in the packet header.

In some cases, when assistance information is configured, the assistance information alone, or a mission session ID and the assistance information together, or a data session ID and the assistance information together, or a mission session ID, a data session ID and the assistance information together, should be enough to distinguish which data session a packet received from/delivered to a tunnel shared by mission sessions belongs to, and need to be encapsulated in the packet.

In some cases, the assistance information may be one or more of: an action ID identifying an action of data processing, a CBID identifying a CB, a step ID identifying a step of a procedure, and a mission customer ID identifying a customer of a mission session. The data processing may be but not limited to AI training, AI inference, data pre-processing, data de-privatization (data privacy protection), data cleaning, data collection, data analytics, sensing, data sanitization, data management, data normalization, useless data filtering, data feature engineering, data compression, data embedding, data representation learning, and data feature extraction.

In some cases, one or more of: a mission session ID, a data session ID and assistance information to be detected or encapsulated in a packet are configured by a C/M plane function (e.g., an MCF) to the network entity. In some cases, before the configuration, the data session ID and/or the assistance information (e.g., to be detected from packet by a network entity) are reported to the C/M plane function by a peer node (e.g., a Data-TW-GW) of the network entity.

For the following descriptions on a CB entity container, they are described taking that mission session ID, data (or inter-GW) session ID and assistance information are all included in a packet as an example, which can be extended to other cases, e.g., where a mission session ID and a data (or inter-GW) session ID or assistance information is included in packet.

In some cases, a data session includes one or more QoS flows. The one or more QoS flows are transmitted via the data session. The content of a CB entity container includes a QFI and/or a CBID. That is, the information on a mission session may include the QFI and/or a CBID. A network entity (e.g., a CB entity, a Data-TW-GW) may use a received QFI to determine a QoS flow and a QoS profile which are associated with the received packet of the data session of the mission session and use a received CBID to determine a CB associated with the GTP-U packet.

FIG. 23 is a schematic illustration of a format of DL CB entity information according to one or more embodiments of the present disclosure. In some cases, a format of information (e.g., CB entity information) included in a CB entity container for a downlink packet (e.g., an ingress packet) is shown in FIG. 23 (which is an evolved figure of FIG. 10).

Referring to FIG. 23, the CB entity container for a downlink packet includes new fields of: a mission session ID, a data session ID and assistance information (e.g., an action ID) for the data session ID. The information on a mission session may include information carried in the new fields.

Similarly, information (e.g., CB entity information) included in a CB entity container for an uplink packet includes new fields of: a mission session ID, a data session ID and assistance information (e.g., an action ID) for the data session ID, and a corresponding evolved figure of FIG. 11 of the format is omitted here.

It should be noted that the location of the new fields in the CB entity container is not limited, e.g., within, before, or after other fields. For example, the new fields can be in, before, or after the field of padding.

When a network entity receives a packet including a CB entity container from a tunnel shared by mission sessions, the network entity can determine (optional a QFI of) a data session of the mission session which the packet belongs to. The mission session can be determined based on the mission session ID. The data session can be determined based on the data session ID and/or assistance information (e.g., an action ID) encapsulated in the packet (e.g., a packet header). The QoS flow can be determined based on the QFI.

The type of a Data-TW-GW container may be indicated with a specific field value (e.g., next extension header field value), e.g., 1000 1100 or another reserved value.

There is a Data-TW-GW container encapsulated in a GTP-U packet when the type of the extension header is set to a Data-TW-GW container (e.g., with a next extension header field value being set to 10001100). Such Data-TW-GW container extension header may be transmitted over a network interface, between network entities, e.g., between CB entities, between a CB entity and a Data-TW-GW. The CB entity may be in a device, a RAN, a CN and a DN. The Data-TW-GW may be in a device, a RAN, a CN and a DN. In some cases, the Data-TW-GW may be a UPF or an evolved UPF. The Data-TW-GW container may have a variable length. And the Data-TW-GW container includes information (control information elements, data processing and/or data forwarding instruction information) to be associated with a data session and/or an inter-GW session of a mission session.

One or more of: a mission session ID, a data session ID and assistance information for data session, inter-GW session ID and assistance information for inter-GW session, are included in the mission session container. Based on the one or more of the mission session ID, the data session ID and assistance information for data session, inter-GW session ID and assistance information for inter-GW session, the network entity (e.g., a Data-TW-GW) can detect and distinguish which data (inter-GW) session a packet received from the tunnel shared by multiple mission sessions belongs to.

The assistance information for data session is used to assist in distinguishing which data session a packet received from/delivered to a tunnel shared by mission sessions belongs to.

The assistance information for inter-GW session is used to assist in distinguishing which inter-GW session a packet received from/delivered to a tunnel shared by mission sessions belongs to.

In some cases, when a mission session ID and a data (inter-GW) session ID together are enough to be used to distinguish which data (inter-GW) session a packet received from/delivered to a tunnel shared by mission sessions belongs to, and the mission session ID and the data (inter-GW) session ID together are encapsulated into the packet (e.g., a packet header, or a packet payload), assistance information needs not to be included in the packet. For example, when a value of a data (inter-GW) session ID is assigned globally unique within a mission session, and the value of a mission session ID is assigned globally unique among different mission sessions, the mission session ID and the data (inter-GW) session ID together are enough to be used to distinguish packets.

In some cases, when a data (inter-GW) session ID alone is enough to be used to distinguish which data (inter-GW) session a packet received from/delivered to a tunnel shared by mission sessions belongs to, and the data (inter-GW) session ID is encapsulated into the packet (e.g., a packet header, or a packet payload), assistance information needs not to be included in the packet. For example, when a data (inter-GW) session ID is assigned globally unique among different data (inter-GW) session IDs of all data (inter-GW) sessions for all mission sessions established between two network entities, the data (inter-GW) session ID alone is enough to be used to distinguish packets.

In some cases, when a mission session ID and a data (inter-GW) session ID together are not enough to distinguish which data (inter-GW) session a packet received from/delivered to a tunnel shared by mission sessions belongs to, assistance information needs to be included in packet header.

In some cases, when a mission session ID and a data (inter-GW) session ID together are enough to distinguish which data (inter-GW) session a packet received from/delivered to a tunnel shared by mission sessions belongs to, but either the mission session ID or the data (inter-GW) session ID (e.g., only the mission session ID, or the data (inter-GW) session ID is encapsulated in the packet) is not encapsulated into the packet (e.g., a packet header, or a packet payload), assistance information needs to be included in the packet header.

In some cases, when assistance information is configured, the assistance information alone, or a mission session ID and the assistance information together, or a data (inter-GW) session ID and the assistance information together, or a mission session ID, a data (inter-GW) session ID and the assistance information together, should be enough to distinguish which data (inter-GW) session a packet received from/delivered to a tunnel shared by mission sessions belongs to, and need to be encapsulated in the packet.

In some cases, the assistance information may be one or more of: an action ID identifying an action of data processing, a CBID identifying a CB, a step ID identifying a step of a procedure, and a mission customer ID identifying a customer of a mission session. The data processing may be but not limited to AI training, AI inference, data pre-processing, data de-privatization (data privacy protection), data cleaning, data collection, data analytics, sensing, data sanitization, data management, data normalization, useless data filtering, data feature engineering, data compression, data embedding, data representation learning, and data feature extraction.

In some cases, one or more of: a mission session ID, a data session ID and assistance information for data session, and inter-GW session ID and assistance information for inter-GW session to be detected or encapsulated in a packet are configured by a C/M plane function (e.g., an MCF) to the network entity. In some cases, before the configuration, the data (inter-GW) session ID and/or the assistance information (e.g., to be detected from packet by a network entity) are reported to the C/M plane function by a peer node (e.g., Data-TW-GW) of the network entity.

For the following descriptions on a Data-TW-GW container, taking that mission session ID, data session ID and assistance information for data session all included in packet as an example, it can be extended to the other cases, e.g., where mission session ID, inter-GW session ID and assistance information for inter-GW session are included while data session ID and assistance information for data session are not included in packet.

In some cases, a data (inter-GW) session includes one or more QoS flows. The one or more QoS flows are transmitted via the data (inter-GW) session. The content of a Data-TW-GW container includes a QFI and/or a CBID. That is, the information on a mission session may include the QFI and/or a CBID. A network entity (e.g., a CB entity, a Data-TW-GW) may use a received QFI to determine a QoS flow and a QoS profile which are associated with the received packet of the data (inter-GW) session of the mission session, and use a received CBID to determine a CB associated with the GTP-U packet.

FIG. 24 is a schematic illustration of a format of DL GW entity information according to one or more embodiments of the present disclosure. In some cases, a format of information (e.g., Data-TW-GW information) included in a Data-TW-GW container for a downlink packet (e.g., an ingress packet) is shown in FIG. 24 (which is an evolved figure of FIG. 10).

Referring to FIG. 24, the Data-TW-GW container for a downlink packet includes new fields of: a mission session ID, a data session ID and assistance information (e.g., an action ID) for the data session ID, and an inter-GW session ID and assistance information (e.g., an action ID) for the inter-GW session ID. The information on a mission session may include information carried in the new fields.

Similarly, information (e.g., Data-TW-GW information) included in a Data-TW-GW container for an uplink packet includes new fields of: a mission session ID, a data session ID and assistance information (e.g., an action ID) for the data session ID, and an inter-GW session ID and assistance information (e.g., an action ID) for the inter-GW session ID, and a corresponding evolved figure of FIG. 11 of the format is omitted here.

It should be noted that the location of the new fields in the Data-TW-GW container is not limited, e.g., within, before, or after other fields. For example, the new fields can be in, before, or after the field of padding.

When a network entity receives a packet including a Data-TW-GW container from a tunnel shared by mission sessions, the network entity can determine (optional a QFI of) a data (inter-GW) session of the mission session which the packet belongs to. The mission session can be determined based on the mission session ID encapsulated in the packet (e.g., a packet header). The data (inter-GW) session can be determined based on the data (inter-GW) session ID and assistance information (e.g., an action ID) encapsulated in the packet (e.g., a packet header). The QoS flow can be determined based on the QFI.

In some cases, if a data (inter-GW) session instead of a QoS flow is the finest granularity of traffic, a QFI is not included in the GTP-U header, e.g., the data (inter-GW) session and/or assistance information replace the fields of QFI in FIGS. 10 and 11; otherwise, QFI together with the new fields are included in the GTP-U header.

Specifically, in the case of reusing an existing GTP-U extension header, a GTP-U tunnel is configured per network entity. The tunnel is shared by multiple mission sessions. A PDU session container (or another container, e.g., a RAN container, and etc.) is reused instead of defining a new type of GTP-U extension header of. In some cases, the information conveyed in the PDU session container may be as shown in FIGS. 10 or 11. And the second type of GTP-U extension header may be referred to as the PDU session container, the RAN container, a (new radio) NR RAN container, or an Xw RAN container, and the like. It should be noted that the PDU session container is taken as an example for explaining.

The characteristic and use of the PDU session container may follow the methods of the general GTP-U extension header described in FIGS. 7, 8 and 9.

It should be noted that, the format of the GTP-U extension headers may be referred to as the format described in FIG. 9.

When one or more of: a mission session ID, a data session ID (and/or assistance information) and an inter-GW session ID (and/or assistance information) are included in a PDU session container, it implicitly indicates that the PDU session container is for a mission session; otherwise, it is for a PDU session.

In some cases, the PDU session container includes an indication to distinguish that the PDU session container is for a PDU session or a network entity. For example, the indication may be 2 bits.

In some cases, the indication may also be located outside from the PDU session container. For example, a field value (e.g., a next extension header field value) for the PDU session container is extended to distinguish that the PDU session container is for a PDU session, or a mission session. For example, 1000 0101 indicates the packet is associated with a PDU session, 10001011 or 1000 1100 indicates the packet is associated with a mission session. As another example, the indication (e.g., the 2 bits) may be in a field of a TEID. As another example, a first range of TEIDs may be reserved for a PDU session, a second range of TEIDs may be reserved for network entity participating in a mission session (including a CB entity and a GW entity). The second field included in the information on a mission session may be referred to as the TEID cited above.

In some cases, a format of information (e.g., PDU session information) included in a PDU session container for a downlink packet (e.g., an ingress packet) may be as shown in FIGS. 23 or 24. That is, the above information on a mission session may also be included in the PDU session container.

Similarly, PDU session information included in a PDU session container for an uplink packet also includes the new fields, and a corresponding evolved figure of FIG. 11 is omitted here.

It should be noted that the location of the new fields in the PDU session container is not limited, e.g., within, before, or after other fields. For example, the new fields can be in, before, or after the field of padding.

When a network entity receives a packet including the new fields (and optional a QFI, e.g., the QFI is included if the data (inter-GW) session includes one or more QoS flows) from a tunnel, the network entity can determine a mission session, or (optional a QFI of) a data (inter-GW) session of a mission session which the packet belongs to. The mission session can be determined based on the mission session ID encapsulated in the packet (e.g., a packet header). The data session can be determined based on the data session ID and/or assistance information (e.g., an action ID) encapsulated in the packet (e.g., a packet header). The inter-GW session can be determined based on the inter-GW session ID and/or assistance information (e.g., an action ID) encapsulated in the packet (e.g., a packet header). The QoS flow can be determined based on the QFI.

The description above does not limit a location of the new field in the GTP-U packet. In some cases, the new fields (e.g., a data session ID, an inter-GW session ID, assistance information) are in other location of the GTP-U header, e.g., in a TEID.

In some cases, a range values of TEIDs may be reserved for a data session.

In some cases, a range values of TEIDs may be reserved for an inter-GW session.

In some cases, a range values of TEIDs may be reserved for a mission session.

In some cases, a type of “CB entity container” or “Data-TW-GW container” is not defined. For example, a range values of TEIDs may be reserved for a CB entity or a Data-TW-GW, based on which the network entity can know that the GTP-U packet belongs to a CB entity or a Data-TW-GW instead of other nodes (e.g., RAN nodes).

Next, embodiments of products related to the communication methods will be described.

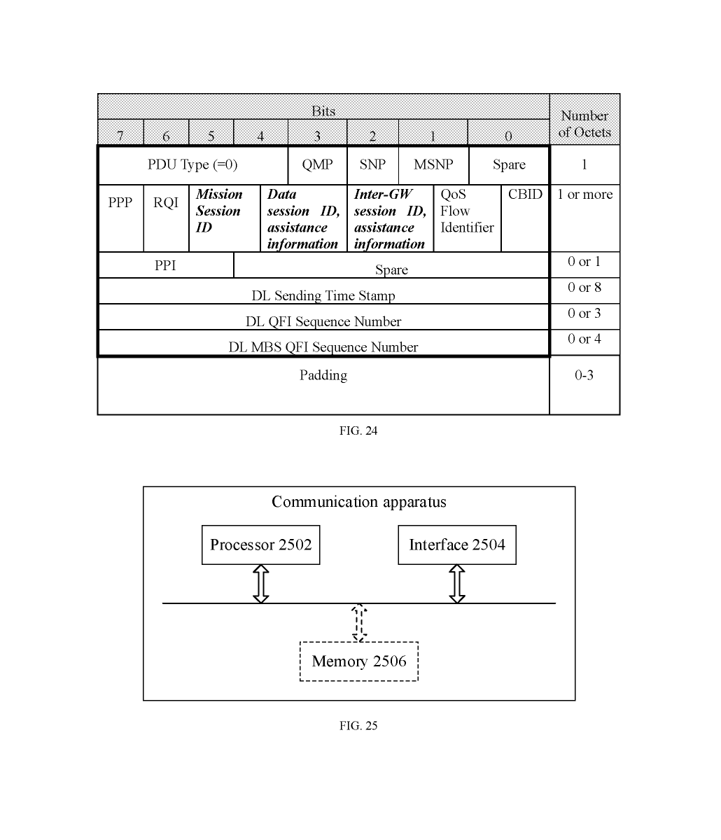

FIG. 25 is a structural diagram of a communication apparatus according to one or more embodiments of the present disclosure. The communication apparatus may be the first network function or the second network function cited above. As shown in FIG. 25, the apparatus includes at least one processor 2502, an interface 2504 for communicating with other devices and a memory 2506. Among them, the memory 2506 may be stored with computer execution instructions, and the processor 2502 executes computer execution instructions stored in the memory 2506 to enable the apparatus to execute any of the above communication methods. It should be noted that, the memory 2506 may be included or excluded from the apparatus, depending on actual needs.

An embodiment of the present disclosure provides a communication apparatus, the communication apparatus may include:

a receiving module, configured to receive a packet; and

a transmitting module, configured to transmit a general packet radio service (GPRS) tunneling protocol for user plane (GTP-U) packet generated based on the packet and GTP-U protocol, where the GTP-U packet includes information on a mission session, the mission session is to provide a mission service to a mission customer, and the mission service is a service for both protocol data unit (PDU) connectivity and data processing.

An embodiment of the present disclosure provides a communication apparatus, the communication apparatus may include:

a receiving module, configured to receive a general packet radio service (GPRS) tunneling protocol for user plane (GTP-U) packet, where the GTP-U packet is a packet based on GTP-U protocol, the GTP-U packet includes information on a mission session, the mission session is to provide a mission service to a mission customer, and the mission service is a service for both protocol data unit (PDU) connectivity and data processing; and

a determining module, configured to determine, according to the information on a mission session, which mission session the GTP-U packet belongs to.

An embodiment of the present disclosure provides an apparatus including processing circuitry for performing any of the above communication methods.

It should be noted that the apparatus in the present disclosure may also be implemented as a device, or one or more component included in a device, such as, a processor or a chip. The device may be user equipment, a terminal, a network device, a network function, a network node, or another network element, which is not limited in the present disclosure.

An embodiment of the present disclosure provides a chip, including an input/output (I/O) interface and a processor, where the processor is configured to call and run a computer program stored in a memory, to enable a device installing with the chip to perform any of the above communication methods.

An embodiment of the present disclosure provides an apparatus, including: one or more processors, the one or more processors is configured to execute instructions stored in a memory, when the instructions are executed by the one or more processors, any of the above communication methods is performed.

It should be understood that the processor may be an integrated circuit chip and has a signal processing capability. In an implementation process, steps of the foregoing method embodiments may be completed by using a hardware integrated logic circuit in the processor, or by using instructions in a form of software. The processor may be a general-purpose processor, a central processing unit (CPU), a graphics processing unit (GPU), a neural processing unit (NPU), a system on chip (SoC) or another programmable logic device, a discrete gate or transistor logic device, or a discrete hardware component. The processor may implement or perform the methods, the steps, and the logical block diagrams that are disclosed in the embodiments of the present disclosure. The general-purpose processor may be a microprocessor, or the processor may be any conventional processor or the like. The steps of the methods disclosed with reference to the embodiments of the present disclosure may be directly performed and completed by a hardware decoding processor, or may be performed and completed by using a combination of hardware in the decoding processor and a software module. The software module may be located in a mature storage medium in the art, such as a random-access memory, a flash memory, a read-only memory, a programmable read-only memory, an electrically erasable programmable memory, or a register. The storage medium is located in the memory, and the processor reads information in the memory and completes the steps of the foregoing methods in combination with hardware in the processor.

It may be understood that the memory in the embodiments of the present disclosure may be a volatile memory or a non-volatile memory, or may include both a volatile memory and a non-volatile memory. The non-volatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random-access memory (Random Access Memory, RAM) and is used as an external cache. By way of example rather than limitation, many forms of RAMs may be used, and are, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchronous link dynamic random access memory (Synchronous link DRAM, SLDRAM), and a direct rambus random access memory (Direct Rambus RAM, DR RAM).

It should be noted that the memory in the systems and the methods described in this specification includes but is not limited to these memories and a memory of any other appropriate type.

An embodiment of the present disclosure provides a communication system, including: the apparatus executing any of the above communication methods.

An embodiment of the present disclosure provides a non-transitory computer-readable medium carrying a program code which, when executed by a processor, any of the above communication methods is performed.

Optionally, the storage medium may be specifically a memory.

An embodiment of the present disclosure provides a computer program product including computer code for performing any of the above communication methods.

Note that when the request or the response mentioned above includes multiple different contents for indicating multiple different pieces of information, the multiple contents can be indicated separately in multiple request/response messages or together in a request/response message.

Note that the network elements mentioned in the present disclosure are all logical network elements, which can be implemented as individual devices, or can be implemented as chips or modules that could be integrated into a certain device.

Although the present disclosure describes methods and processes with steps in a certain order, one or more steps of the methods and processes may be omitted or altered as appropriate. One or more steps may take place in an order other than that in which they are described, as appropriate.

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein. The machine-executable instructions may be in the form of code sequences, configuration information, or other data, which, when executed, cause a machine (e.g., a processor or other processing device) to perform steps in a method according to examples of the present disclosure.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may include a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

Although embodiments have been described above with reference to the accompanying drawings, those of skill in the art will appreciate that variations and modifications may be made without departing from the scope thereof as defined by the appended claims.

Please note that the different examples may be implemented separately or combined. Although a combination of features is shown in the illustrated embodiments, not all of them need to be combined to realize the benefits of various examples of the present disclosure. In other words, a system or method designed according to an embodiment of the present disclosure will not necessarily include all of the features shown in any one of the figures or all of the portions schematically shown in the figures. Moreover, selected features of one example embodiment may be combined with selected features of other example embodiments.

Although this disclosure has been described with reference to illustrative embodiments, the description is not intended to be construed in a limiting sense. Various modifications and combinations of the illustrative embodiments, as well as other examples of the disclosure, will be apparent to persons skilled in the art upon reference to the description. It is therefore intended that the appended claims encompass any such modifications or embodiments.

What is claimed is:

1. A method, comprising:
receiving a general packet radio service (GPRS) tunneling protocol for user plane (GTP-U) packet, wherein the GTP-U packet is based on GTP-U protocol, the GTP-U packet includes information on a mission session, the mission session is to provide a mission service to a mission user, and the mission service is for protocol data unit (PDU) connectivity and data processing; and
determining, according to the information on the mission session, which mission session the GTP-U packet belongs to.

2. The method according to claim 1, wherein the mission session comprises one or more data sessions, each data session of the one or more data sessions comprises an association that terminates at a computing block (CB) entity executing at least one CB of a mission, the mission comprises one or more CBs, and each CB of the one or more CBs corresponds to a computational step towards achieving the mission service.

3. The method according to claim 2, wherein the CB entity is deployed in one of: a device, a radio access network (RAN), a core network (CN), or a data network (DN).

4. The method according to claim 2, wherein the computational step towards achieving the mission service comprises one or more of: artificial intelligence (AI) training, AI inference, data pre-processing, data privacy protection, data cleaning, data collection, data analytics, sensing, data sanitization, data management, data normalization, data aggregation, data splitting, useless data filtering, data formatting, data adaptation, data feature engineering, data compression, data embedding, data representation learning, or data feature extraction.

5. The method according to claim 1, wherein the mission session further comprises one or more inter-gateway (GW) sessions, each inter-GW session of the one or more inter-GW sessions comprises an association between two GW entities, and each GW entity of the two GW entities supports communication among CB entities.

6. The method according to claim 1, wherein the GTP-U packet is transmitted through a GTP-U tunnel, and the GTP-U tunnel is dedicated for a data session.

7. The method according to claim 6, wherein the information on the mission session includes at least one of a quality of service (QoS) flow identifier (QFI) or a computing block ID (CBID), wherein the QFI indicates a QoS flow associated with the GTP-U packet, the QoS flow is one of one or more QoS flows included in the data session, the CBID indicates a first CB associated with the GTP-U packet, and the data session corresponds to one or more CBs including the first CB.

8. The method according to claim 7, wherein the information on the mission session is included in a packet header of the GTP-U packet, the packet header includes a GTP-U extension header, and the at least one of the QFI or the CBID is included in the GTP-U extension header.

9. The method according to claim 8, wherein the GTP-U extension header is a first type of GTP-U extension header, and the first type of GTP-U extension header is a data session container.

10. The method according to claim 1, wherein the GTP-U packet is transmitted through a GTP-U tunnel, and the GTP-U tunnel is dedicated for an inter-GW session.

11. The method according to claim 10, wherein the information on the mission session includes at least one of a QFI or a CBID, wherein the QFI indicates a QoS flow associated with the GTP-U packet, the QoS flow is one of one or more QoS flows included in the inter-GW session, the CBID indicates a first CB associated with the GTP-U packet, and one data session or one inter-GW session corresponds to one or more CBs including the first CB.

12. The method according to claim 1, wherein the GTP-U packet is transmitted through a GTP-U tunnel, and the GTP-U tunnel is dedicated for the mission session and is shared by at least one of one or more data sessions or one or more inter-GW sessions of the mission session.

13. The method according to claim 12, wherein the information on the mission session includes either or both of a data session ID and assistance information, the data session ID identifies a data session included in the one or more data sessions, and the assistance information is used for assisting in distinguishing the data session or distinguishing a CB.

14. The method according to claim 12, wherein the information on the mission session includes at least one of a QFI or a CBID, wherein the QFI indicates a QoS flow associated with the GTP-U packet, the QoS flow is one of one or more QoS flows of the mission session, the CBID indicates a first CB associated with the GTP-U packet, and one data session or one inter-GW session corresponds to one or more CBs including the first CB.

15. The method according to claim 14, wherein the information on the mission session is included in a packet header of the GTP-U packet, the packet header includes a GTP-U extension header, and one or more of a data session ID, an inter-GW session ID, assistance information, the QFI, or the CBID is included in the GTP-U extension header.

16. The method according to claim 1, wherein the GTP-U packet is transmitted through a GTP-U tunnel, the GTP-U tunnel is dedicated for a CB entity and is shared by one or more mission sessions of the CB entity, and the one or more mission sessions include the mission session.

17. The method according to claim 16, wherein the information on the mission session includes one or more of: a mission session ID, a data session ID, or assistance information; the mission session ID identifies a first mission session, the data session ID identifies a data session included in the first mission session; and the assistance information is used for assisting in distinguishing the data session or distinguishing a CB.

18. The method according to claim 16, wherein the information on the mission session includes at least one of a QFI or a CBID, wherein the QFI indicates a QoS flow associated with the GTP-U packet, the QoS flow is one of one or more QoS flows of the one or more mission sessions of the CB entity, the CBID indicates a first CB associated with the GTP-U packet, and a data session corresponds to one or more CBs including the first CB.

19. An apparatus, comprising:
at least one processor; and
a non-transitory computer readable storage medium storing programming, the programming including instructions that, when executed by the at least one processor, cause the apparatus to perform operations including:
receiving a general packet radio service (GPRS) tunneling protocol for user plane (GTP-U) packet, wherein the GTP-U packet is based on GTP-U protocol, the GTP-U packet includes information on a mission session, the mission session is to provide a mission service to a mission user, and the mission service is for protocol data unit (PDU) connectivity and data processing; and
determining, according to the information on the mission session, which mission session the GTP-U packet belongs to.

20. A non-transitory computer-readable storage medium having instructions stored thereon which, when executed by an apparatus, cause the apparatus to perform operations including:
receiving a general packet radio service (GPRS) tunneling protocol for user plane (GTP-U) packet, wherein the GTP-U packet is based on GTP-U protocol, the GTP-U packet includes information on a mission session, the mission session is to provide a mission service to a mission user, and the mission service is for protocol data unit (PDU) connectivity and data processing; and
determining, according to the information on the mission session, which mission session the GTP-U packet belongs to.
